(19) United States
(12) Patent Application Publication
(10) Pub. No.: US 2007/0050812 A1
(43) Pub. Date: Mar. 1, 2007

(54) Data distribution control system

(76) Inventors: Tomoichi Ebata, Machida (JP); Sadayuki Kina, Yokohama (JP); Tomihiro Miwa, Urayasu (JP); Narihiro Omoto, Ichikawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/494,706

(22) Filed: Jul. 28, 2006

(30) Foreign Application Priority Data
Aug. 25, 2005 (JP) 2005-243554

(51) Int. Cl. H04N 5/445; G06F 3/00; G06F 13/00; H04N 7/16

(52) U.S. Cl. 725/40; 725/39; 725/8; 725/41

(57) ABSTRACT

A data distribution control system is provided, to which a terminal owned by a user, a plurality of computers for transmitting/receiving data, and a control apparatus for controlling data transmitted/received between the computers and the terminal are connected; in which the terminal-transmits first data to the control apparatus; when the control apparatus receives the first data, the control apparatus selects such a computer related to the terminal from the plurality of computers based upon the first data and-second data which includes attribute information previously registered in the control apparatus; the control apparatus transmits third data which contains positional information of the terminal and attribute information of the user with respect to the selected computer; and when the selected computer receives the third data, the selected computer transmits fourth data in order to call the user with respect to the terminal.

### INCORPORATION BY REFERENCE

The present application claims priority from Japanese application JP2005-243554 filed on Aug. 25, 2005, the content of which is hereby incorporated by reference into this application.

### BACKGROUND OF THE INVENTION

The present invention is related to a system for distributing advertisements with respect to users who own portable terminals.

Very recently, in contrast to mas-marketing ideas in which a large amount of advertisements are distributed to general persons, One-To-One Web marketing ideas are known in which more proper marketing activities are carried out with respect to individual users based upon attribute information of these users, for instance, personal tastes of these users and user action characteristics (refer to “Internet World Guide to One-To-One Web Marketing “written by Cliff Allen, Deborah Kania, Beth Yaeckel, published by John Wiley & Sons Inc., March in 1998).

On the other hand, as services utilizing portable telephones, such an advertisement distribution service is known by which shops who are selling goods in the actual world distribute advertisements in response to presence positions of users (refer to JP-A-2002-183007). This advertisement distribution service may own such an effect that since consumers are located in the vicinity of actual goods, this service may directly conduct consuming activities of these consumers, as compared with advertisement distribution services using the Internet.

### SUMMARY OF THE INVENTION

The above-explained marketing idea “Internet World Guide to One-To-One Web Marketing” performs the marketing activities in the effective manner based upon the personal attribute information of the users with respect to the users who use the Internet, namely, the users under static environments, but not with respect to users under dynamic environments. In this case, a dynamic environment should be understood as such an environment that a condition is changed since a user himself is moved in an actual world.

On the other hand, the advertisement distribution service described in JP-A-2002-183007 is directed to distribute advertisements in response to presence positions of users, but merely distributes these advertisements in a broadcasting manner, which does not perform the advertisement distributions in an effective manner.

In other words, this advertisement distribution service does not consider such a distribution method by which users are effectively selected in a real time with respect to users under such a dynamic environment and advertisements are distributed to these selected users. As a consequence, there are such problems that the efficiency of the advertisement distribution is not high on the side of the advertisement distributing party, and also, the advertisement receiving party has such cumbersome feelings that unnecessary advertisements must be received.

Accordingly, an object of the present invention is to realize a system capable of effectively selecting users from users under dynamic environments, and capable of distributing an advertisement to the selected users.

To solve the above-explained problems, a data distribution control system, according to one desirable aspect of the present invention, is featured by such a data distribution control system to which a terminal owned by a user, a plurality of computers for transmitting/receiving data, and a control apparatus for controlling data transmitted/received between the computers and the terminal are connected; in which the terminal transmits first data to the control apparatus; when the control apparatus receives the first data, the control apparatus selects such a computer related to the terminal from the plurality of computers based upon the first data and second data which includes attribute information previously registered in the control apparatus; the control apparatus transmits third data which contains positional information of the terminal and attribute information of the user with respect to the selected computer; and when the selected computer receives the third data, the selected computer transmits fourth data in order to call the user with respect to the terminal.

Other objects, features and advantages of the invention will become apparent from the following description of the embodiments of the invention taken in conjunction with the accompanying drawings.

### BRIEF DESCRIPTION OF THE DRAWINGS

FIG. 1 is a structural diagram of a data distribution control system according to an embodiment of the present invention.

FIG. 2A to FIG. 2D are diagrams for representing data structural examples: FIG. 2A shows a program list DB; FIG. 2B indicates a contents DB; FIG. 2C represents a user DB; and FIG. 2D shows an advertisement DB.

FIG. 3 is a flow chart for explaining a sequential operation example 1 of a data distributing method according to the present invention.

FIG. 4 is a flow chart for describing a sequential operation example 2 of the data distributing method according to the present invention.

FIG. 5 is a flow chart for explaining a sequential operation example 3 of the data distributing method according to the present invention.

FIG. 6 is a flow chart for describing a sequential operation example 4 of the data districting method according to the present invention.

FIG. 7 is a diagram for indicating a structural image of the program list.

FIG. 8 is a diagram for representing an image of a scroll control of contents.

FIG. 9 is a flow chart for explaining a sequential operation example 5 of the data distributing method according to the present invention.

FIG. 10 is a diagram for showing a screen transition example 1.

FIG. 11 is a diagram for indicating a screen transition example 2.

FIG. 12 is a diagram for showing a screen transition example 3.

FIG. 13 is a diagram for indicating a screen transition example 4.

FIG. 14 is a diagram for showing a screen transition example 5.

FIG. 15 is a flow chart for describing process operations for calculating an actual distribution time instant.

FIG. 16 is a flow chart for explaining process operations for registering a requested attribute keyword.

FIG. 17 is a flow chart for explaining process operations in the case that a user directly exchanges a message with a shop.

FIG. 18 is a flow chart for describing process operations for predicting a shop which is actually utilized by the user.

FIG. 19 is a diagram for showing a screen transition example for registering the request attribute keyword.

FIG. 20 is a diagram for indicating a screen transition example for indicating that a shop is selected to be represented.

FIG. 21A and FIG. 21B are diagrams for showing display conditions of the portable terminal.

FIG. 22A and FIG. 22B are diagrams for showing display conditions of a shop terminal.

FIG. 23 is a diagram for showing conditions in the case that enquete is performed in the portable terminal.

FIG. 24A and FIG. 24B are diagrams for representing a display of map data in either the portable terminal or the shop terminal.

### DESCRIPTION OF THE EMBODIMENTS

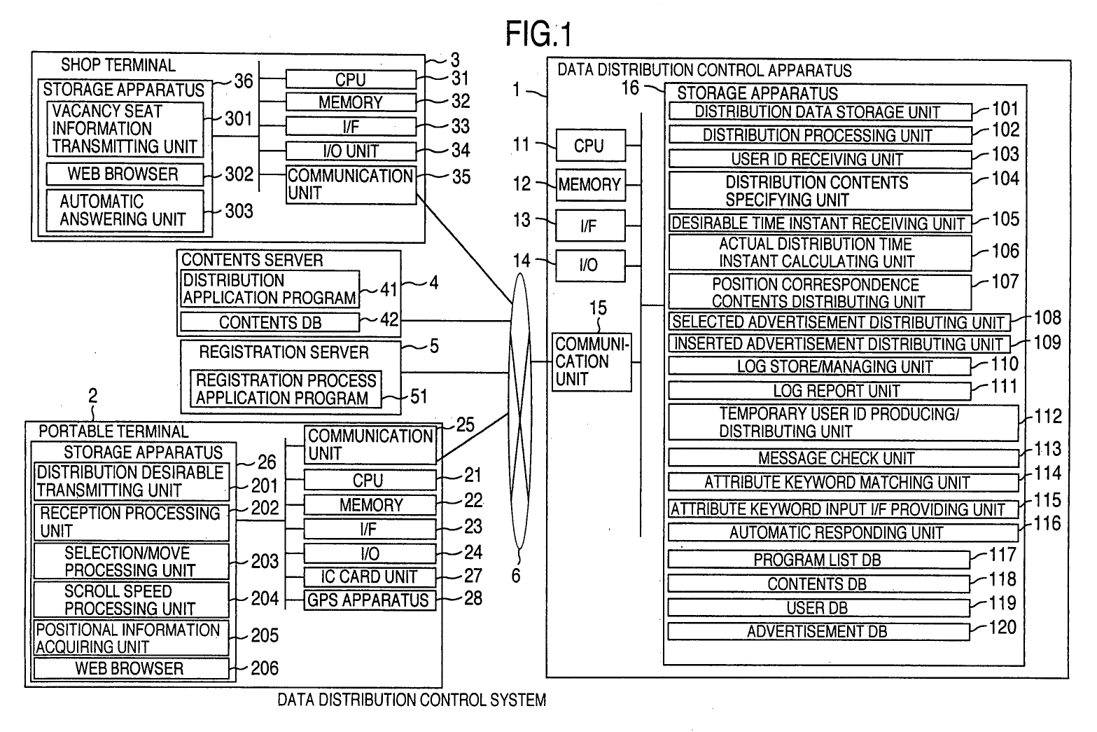

FIG. 1 is a structural diagram for indicating a data distribution control system. This data distribution control system is arranged by a data distribution control apparatus (will be simply referred to as “control apparatus” hereinafter) 1 which controls data transmitted/received between a portable terminal 2 and a shop terminal 3; the portable terminal 2 owned by a user; the shop terminal 3 owned by a shop which distributes an advertisement to the portable terminal 2; a contents server 4 for storing thereinto contents; a registration server 5 for registering a user; and a network 6 which connects these structural elements to each other.

The control apparatus 1 is arranged by a CPU 11; a memory 12; and an input/output interface (will be simply referred to as “I/F” hereinafter) 13 such as a keyboard, buttons, and a display; an I/O unit 14 for performing various sorts of intervening process operations such as buffering of data between a storage apparatus 16 and the own device; a communication unit 15 for transmitting/receiving data via the network 6 between the portable terminal 2, and the like and the own system; and the storage apparatus for storing thereinto programs and data.

The CPU 11 reads the program from the storage apparatus 16 and writes the read program into the memory 12 so as to realize various sorts of functions on a computer.

The storage apparatus 16 stores thereinto various sorts of programs 101 to 116, and various sorts of databases (will be simply referred to as “DB” hereinafter) 117 to 120. The various sorts of DBs 117 to 120 may be alternatively managed by a DBMS (DataBase Management System).

It should be noted that an apparatus for managing various sorts of programs and another apparatus for managing various sorts of DBs may be separately arranged, as exemplified by that the apparatus equipped with the programs 101 to 116 may be arranged as an application server, and also, the apparatus equipped with the various sorts of DBs 117 to 120 may be arranged as a DB server. In general, the storage apparatus 16 is a magnetic disk apparatus. Alternatively, a storage apparatus using other storage media such as an optical disk may be employed. Also, such an arrangement may be realized that the control apparatus 1 owns the function of the contents server 4 and the function of the registration server 5. Furthermore, one of a plurality of shop terminals may be arranged as a representative shop terminal having the function of the control apparatus 1.

In the below-mentioned explanations, as data which is distributed by the control apparatus to the portable terminal 2, “program lists” as to a television, or the like are exemplified. As application examples of distributed data, the present invention is not limited only to the program lists, but also may employ any of lists which indicate combinations made of day times and contents which are wanted to be distributed at the day times. Also, at a time instant when the control apparatus has formed a program list, it is so assumed that distribution desirable time instant information (namely, information related to time instant when user wants to distribute content) contained in the information of the program list has been transmitted to the portable terminal 2. In other words, it is so assumed that the portable terminal 2 is provided with distribution desirable time instant information.

The distribution data storage unit 101 corresponds to a program for storing a program list designated by a user into the program list DB 117 for every portable terminal 2.

The distribution processing unit 102 corresponds to such a program that when a content distribution request (will be simply referred to as “distribution request” hereinafter) is received from the portable terminal 2, distribution desirable contents listed in the program list are distributed to the portable terminal 2.

The user ID receiving unit 103 corresponds to such a program that a user ID transmitted at a time instant based upon the distribution desirable time instant information is received from the portable terminal 2 as a distribution request. In this case, the above-described user ID implies such an information which is used to exclusively identify the user, but may be alternatively equal to information (for instance, specific ID and telephone number of portable telephone) which is used to identify the portable terminal 2. In this case, the user IDs may be allocated by the control apparatus 1. This embodiment will explain that a user and a portable terminal may correspond to each other in a one-to-one relationship, but the present invention is not limited only to this relationship. Also, since time instants and program lists are managed between the control apparatus 1 and the portable terminal 2, there are some effects that an amount of data transmitted and received between the control apparatus 1 and the portable terminal 2 can be reduced; a load given to the portable terminal 2 can be lowered; and a maintenance work of the control apparatus 1 can be carried out in an easy manner.

The distribution contents specifying unit 104 corresponds to such a program that a program list corresponding to the relevant user is retrieved from the program list DB 117 based upon the user ID, and a content set to the distribution desirable time instant of this retrieved program list is specified. In this case, the specified content is extracted from the content DB 118 by the distribution processing unit 102 so as to be transmitted to this portable terminal 2.

The desirable time instant receiving unit 105 corresponds to such a program that the distribution desirable time instant information is received as a distribution request from the portable terminal 2.

The actual distribution time instant calculating unit 106 corresponds to a program for calculating an actual distribution time instant. The actual distribution time instant will be described later. In this case, the content is extracted from the contents DB 118 based upon the distribution request, and this extracted content is transmitted at this actual distribution time instant to the relevant portable terminal 2 by the distribution processing unit 111.

The position corresponding contents distributing unit 107 corresponds to such a program that present positional information as to the portable terminal 2 is acquired from this portable terminal 2, a content which has been stringed to positional information in the contents DB 118 is specified based upon this acquired present positional information, and then, the specified content is distributed to this portable terminal 2. Also, alternatively, either a registered address of the user, or a temporary location of the user, which have been previously received from the portable terminal 2, may be extracted from the user DB 119 in accordance with this program 109; a content in the contents DB 118 may be specified based upon either the registered address or the temporary location; and then, this specified content may be distributed to the portable terminal 2. Furthermore, advertisement information as to various sorts of facilities located within an area indicated by map data contained in a content may be extracted from the advertisement DB 120 into which the advertisement information for every shop has been stored, and then this extracted advertisement information may be distributed to the portable terminal 2 in order to display this advertisement information on the map data. The facilities contain shops, and therefore, will be referred to as “shops” hereinafter in this embodiment. Also, an icon to which an acquisition request command of advertisement information has corresponded may be alternatively distributed to the portable terminal in such a manner that this icon is displayed on a location of the relevant shop in the map data. Also, one representative icon in which acquisition request commands of advertisement information of the respective shops have corresponded to shop groups located within a location of a predetermined range may be alternatively distributed to the portable terminal 2 in such a manner that one representative icon is displayed on the above-described location in the map data. Also, as advertisement information, such a content may be alternatively distributed to the portable terminal 2, which contains at least one of vacancy seat information within the relevant shop and discount sale information as to goods and services, which have been previously received by the shop terminal 3. Furthermore, an attribute of a user which has been previously received from the portable terminal 2 may be extracted from the user DB 119; and while this attribute information is used as a key, a specific shop may be selected by using such an attribute information which has been previously registered in the user DB 119 in order that various sorts of shops located in the area shown in this map data discover a specific user.

The selected advertisement distributing unit 108 corresponds to such a program that an advertisement information list which has been stored in the advertisement DB 120 and has been registered/examined is shown to the shop terminal 3; a selected item of advertisement information which is wanted to be distributed from the advertisement information list is received from the shop terminal 3; this advertisement information is extracted from the advertisement DB 120; and then, this advertisement information is distributed to the portable terminal 2. Also, such a map data provided with a program may be alternatively distributed to the portable terminal 2 by the position corresponding contents distributing unit 107 to the portable terminal 2, while this program is to receive a move instruction for moving a cursor displayed on a display (note that this display implies display of portable terminal 2 unless specific notification) of the portable terminal 2 along a predetermined direction for a predetermined time from the portable terminal 2, and then, this program is to continuously move selected indications to the plural icons arranged on the map data along the predetermined direction for the predetermined time. Furthermore, a content stored in the contents DB 118 may be alternatively equipped with a program for scrolling this content from one end to the other end of the display at a speed higher than, or equal to a speed at which one end of the content reaches within a predetermined time; and another program for scrolling this content at a speed higher than, or equal to such a speed that after one end of the content has reached the other end of the display, the other end of this content reaches the other end of the display for a predetermined time period.

The inserted advertisement distributing unit 109 corresponds to such a program that in the advertisement DB 120 in which the advertisement information for every shop has been stored, such a advertisement information is retrieved which is provided with an attribute stringed to an attribute of a distribution desirable content; and the retrieved advertisement information is distributed as an inserted advertisement between the distribution desirable contents.

The log string/managing unit 110 corresponds to such a program that as to view histories such as contents of the respective portable terminals 2 and advertisement information thereof, the view histories are stored in the user DB 119. The view histories stored in this user DB 119 may be utilized in the following cases: That is, the control apparatus 1 may propose utilization of contents on the side of users, and selects advertisement information inserted between contents based upon, for example, a view trend of past contents and past advertisement information, and attributes of the users.

The log report unit 111 corresponds to such a program that a log report is produced by inserting information of the view history into a proper form, and this log report is transmitted to the relevant portable terminal 2 and the shop terminal 3 of each of shops which constitutes an advertisement owner.

The temporary user ID producing/distributing unit 112 corresponds to the following program. That is, in the case that a specific user is selected by the position corresponding contents distributing unit 107, a temporary ID is produced which is required in order to be communicated with this specific user within a predetermined time, or a predetermined area; and this produced ID and such a fact that the portable terminal 2 can be discovered which is adapted to the attribute information registered in the user DB 119 are notified to the shop terminal 3. In this case, when a user directly exchanges a message with a shop, such an address is produced which is temporarily and limitedly utilized by the user in order that the address of the user is not disclosed to the shop side; and then, this address is distributed to such a shop terminal 3 which requires this address.

The message checking unit 113 corresponds to such a program that when a user directly exchanges a message to a shop, a check is made as to whether or not an improper description is made in a content of a message which is distributed from the shop side to the user.

The attribute keyword matching unit 114 corresponds to such a program. That is, when a user uses this system, a check is made as to whether or not either an attribute keyword transmitted in combination with positional information of the user or an attribute keyword recorded in the records of the attribute keywords of the user DB 119 is made coincident with such a keyword recorded in the records of the request attribute keywords of the advertisement DB 120; when these keywords are coincident with each other, the coincident shop is notified to the portable terminal 2, and an appearance of the user is notified to the shop terminal 3.

The attribute keyword input I/F providing unit 115 corresponds to such a program that an attribute keyword of a user is inputted which is required by a shop in order to conduct a customer.

The automatic answering unit 116 corresponds to such a program that a conduction of a customer by a shop is automatically performed.

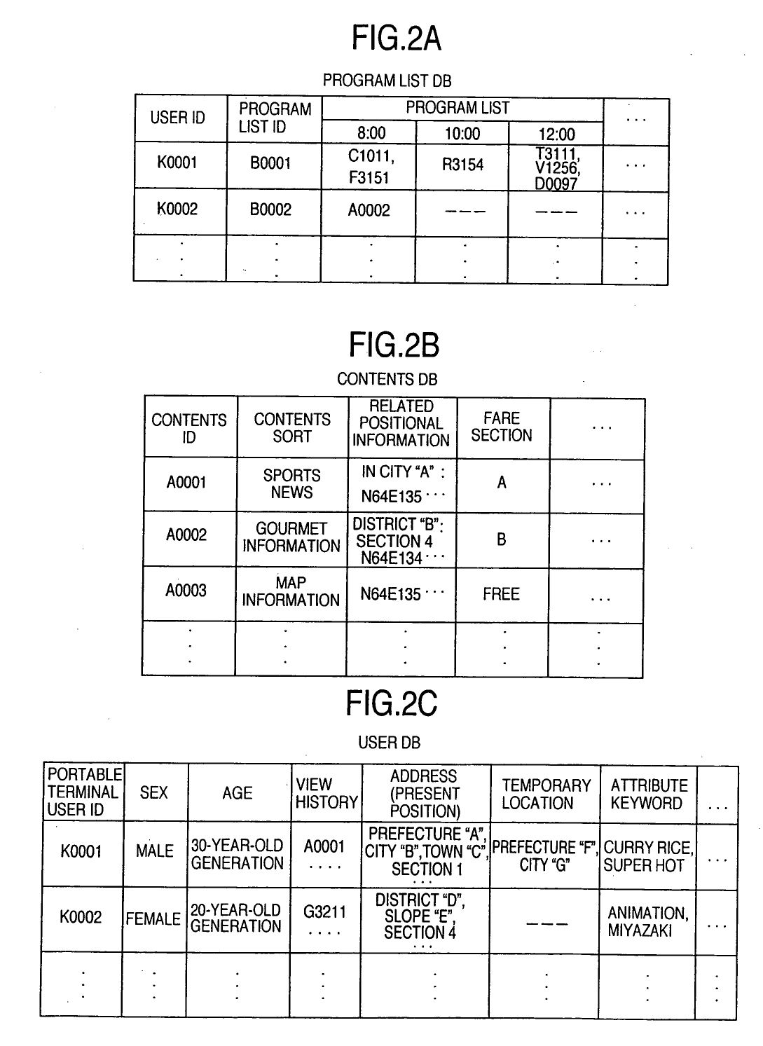

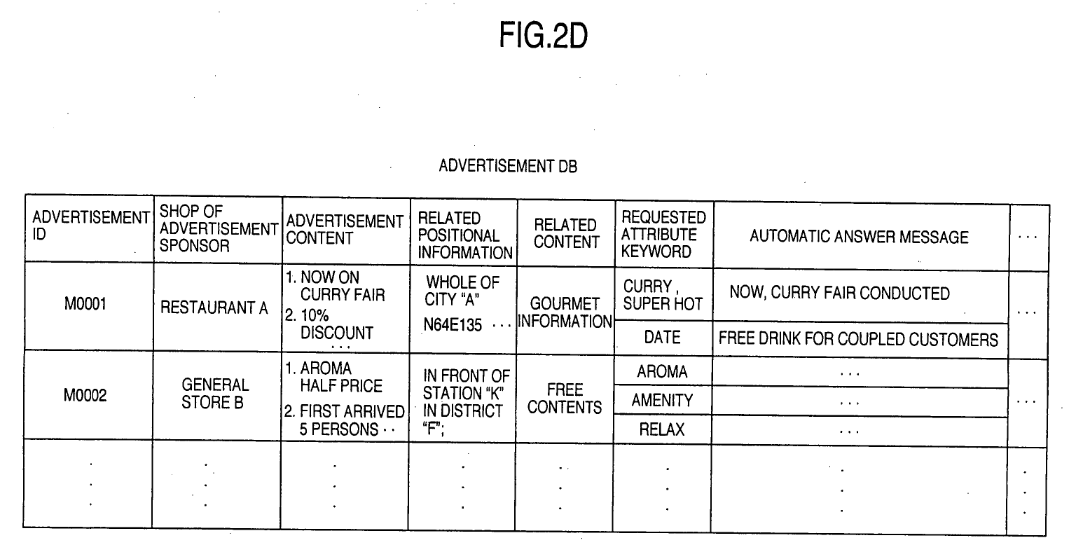

The program list DB 117 corresponds to such a DB (database) that the control apparatus 1 receives from the portable terminal 2, and produces a program list for each of the portable terminals 2 within a predetermined time period based upon such an information (will be referred to as “distribution desirable information” hereinafter) related to a designation for both a distribution desirable content and a distribution desirable time instant, and then stores the produced program lists in this database. The DB 117 is such a database that, for example, this DB 117 is a combined member (refer to FIG. 2A) of records in which various sorts of information such as program list IDs and contents of the program lists are related to each other while a user ID is used as a key. The contents of the program lists are distribution time ranges and IDs of contents to be distributed.

The contents DB 118 corresponds to such a DB which stores thereinto contents which are distributed to the portable terminal 2. For instance, this contents DB 118 is a combined member of records (refer to FIG. 2B) where such information as contents sorts, corresponding positional information, and sections of use fees has been related to each other, for instance, while a content ID is used as a key. It should be noted that the contents DB 118 may be constituted by classifying these contents based upon sorts thereof.

The user DB 119 corresponds to a DB which stores thereinto attribute information of users. This user DB 119 is a combined member (refer to FIG. 2C) where various sorts of the following information have been related to each other, for example, while a user ID is used as a key, namely, view histories such as sex, ages, and contents; addresses (present position); temporary addresses such as travel destinations and destinations of business trips; and attribute keywords of individual users indicative of favorites of users.

The advertisement DB 120 corresponds to such a DB which stores thereinto advertisement information advertised to be inserted between contents, and also, advertisement information which is inserted as contents on map data. This advertisement DB 120 is a combined member of records where various sorts of the following information are related to each other, for instance, while an advertisement ID is used as a key, namely, shops of advertisement sources; contents of advertisements (for instance, sentence underlined in drawing may be selecting changed by other expressions in response to instruction from shop terminal 3); corresponding positional information; and attributes of corresponding contents. Also, this advertisement DB 12) contains such records that describe contents of messages which are automatically answered in the case that a request attribute keyword is matched with a keyword. This keyword indicates that the relevant shop wants to conduct a user having what attribute (refer to FIG. 2D).

The above-explained arrangements contained in the control apparatus 1 are similar to those as to a portable terminal 2, a shop terminal 3, a contents server 4, and a registration server 5, which will be explained later, except that data stored in the storage apparatus 16 are different from each other. Also, as to the contents server 4 and the registration server 5, hardware such as a CPU is omitted. A description is made of different portions from the control apparatus 1 with respect to the respective apparatus.

Various sorts of programs (201 to 206) are stored in a storage apparatus 26 of the portable terminal 2.

The distribution desirable transmitting unit 201 corresponds to such a program which transmits distribution desirable information to the control apparatus 1.

The reception processing unit 202 corresponds to such a program that a distribution desirable content transmitted by the control apparatus 1 in accordance with a program list is received and is displayed on the display.

The selection/move processing unit 203 corresponds to such a program as follows: That is, in such a case that a content distributed form the control apparatus 1 is may data in which an icon is displayed on a location of the relevant shop and this icon is stringed to an acquisition request command of advertisement information of various sorts of shops, a move instruction for moving a cursor to be displayed on the display along a predetermined direction and a predetermined time is received from an I/F 23 in order that a selection indication to each of plural icons arranged on the map data is continuously moved along the predetermined direction and for the predetermined time. It should be understood that this I/F 23 indicates such as an input/output interface as button members and a display. As previously explained, a display is described as a “display”, whereas other interfaces are described as “I/F 23.”

The scroll speed control unit 204 corresponds to such a program that this program scrolls a content distributed from the control apparatus 1 from one end to the other end of the display at a speed higher than, or equal to a speed at which one end of the content reaches within a predetermined time, and this program scrolls the distributed content at a speed higher than, or equal to such a speed that after one end of the content has reached the other end of the display, the other end of this content reaches the other end of the display for a predetermined time period.

The positional information acquiring unit 205 corresponds to such a program which acquires present positional information from a present positional information acquiring apparatus such as a GPS apparatus 28, and transmits this acquired present positional information to the control apparatus 1.

The Web browser 206 corresponds to such a program in which assuming now that the control apparatus 1 is a Web server, and the Web server performs a data communication based upon an http request/response, the Web browser 206 accesses the control apparatus 1. As a result, the Web browser 206 can take a role of outputting contents and the like to the display. Also, the Web browser 206 has been equipped with a real-time message transmitting/receiving function by which a message is directly received via the network 6 from the shot terminal 3, or is received via the control apparatus 1 through the I/F 23, or directly exchanges a real-time message with respect to the shop terminal 3. Also, the Web browser 206 has been provided with a shop adaptive event listener function by which even while the user utilizes this service, an arrival of a message from the shop side is received; an icon is flickered, if necessary; and the message which arrives in connection with this icon is displayed. Furthermore, the Web browser 206 has been equipped with an attribute keyword register purpose interface by which an attribute keyword of a user which is required by that the shop conducts a customer is inputted via the attribute keyword in put I/F providing unit 115 of the control apparatus 1; and this inputted attribute keyword is stored in the records of the requested attribute keyword of the advertisement data DB 119.

An IC card 27 corresponds such a card which owns an antenna inside the own card, and transmits/receives data by utilizing electromagnetic waves having low strengths which are oscillated by an external terminal. This function can disclose specific individual information such as a member certification, and can realize an electronic ticket and a small amount of electronic settlement.

Various sorts of programs (301 to 303) are stored in the storage apparatus 36 of the shop terminal 3 which issues a request with respect to a user.

The vacancy seat transmitting unit 301 corresponds to such a program by which an information input as to a vacancy seat condition in the relevant shop is received from the I/F 33, and then, this received information is transmitted to the control apparatus 1. As a result, for instance, a present vacancy seat condition can be added to the advertisement information of this shop which is provided to the portable terminal 2.

The Web browser 302 is similar to the above-explained Web browser 206. As a result, the Web browser 302 can select advertisement information which constitutes an inserted advertisement, and also, can output various sorts of data in connection with a registration examination request of the advertisement information. Also, this Web browser 302 is similarly equipped with the real-time message transmitted/reception function, and the user adaptive event listener function effected in the case that a new user is discovered and an arrival of a message from the user side is received.

The automatic response unit 303 corresponds to such a program for automatically conducting a customer by a shop.

The contents server 4 corresponds to such a terminal which is used by a providing firm of various sorts of contents such as a broadcasting enterprise, a movie firm, and a publishing firm. In a storage apparatus of this terminal, a distribution application program 41 is stored. The distribution application 41 corresponds to such a program which is used so as to execute a contents distribution process operation to the control apparatus 1. It should also be understood that since various sorts of contents stored in the control apparatus 1 are acquired from the above-explained providing firms, it is so assumed that the control apparatus 1 has been connected via the network 6 to the contents server 4.

The registration server 5 corresponds to such a terminal which is used in order to execute member registration processing operation in advance since the control apparatus 1 distributes contents to the portable terminal 2, while this member registration process operation is carried out by registration process application program 51 which is stored in the storage apparatus of this terminal.

It should also be understood that the respective functions of the programs stored in the control apparatus 1 the portable terminal 2, the shop terminal 3, the contents server 4, and the registration server 5 may be realized as hardware. Also, the above-explained programs may be always provided by the respective apparatus, and the respective apparatus may alternatively acquire these programs via the network 6, or the like from other apparatus.

Further, as the network 6, various sorts of networks may be employed, for instance, the Internet, a LAN, an ATM line and a leased line, a WAN (Wide Area Network) a electric power line network, a wireless network, a public line network, a portable telephone network, a serial interface communication line, an adhoc network, and so on. Also, if such a virtual private network technique as a VPN (Virtual Private Network) is employed, then a communication with higher security can be established when the Internet is employed. It should also be understood that a serial interface implies such an interface which is employed so as to be connected with an external appliance in a serial transmission in which data is sequentially transferred 1 bit by 1 bit by employing a single signal line. As the serial communication system, RS-232C, RS-422, IrDA, USB, IEEE 1394, fiber channel, and the like may be supposed.

A description is made of sequential operations as to data distributing methods. In this example, it is so assumed that while the control apparatus 1 is equipped with the Web server appliance, a data communication is carried out between the portable terminal 2 and the shop terminal 3 via the process operation of http request/response. As a consequence, in this case, the portable terminal 2 accesses the control apparatus 1 by executing the Web browser 206.

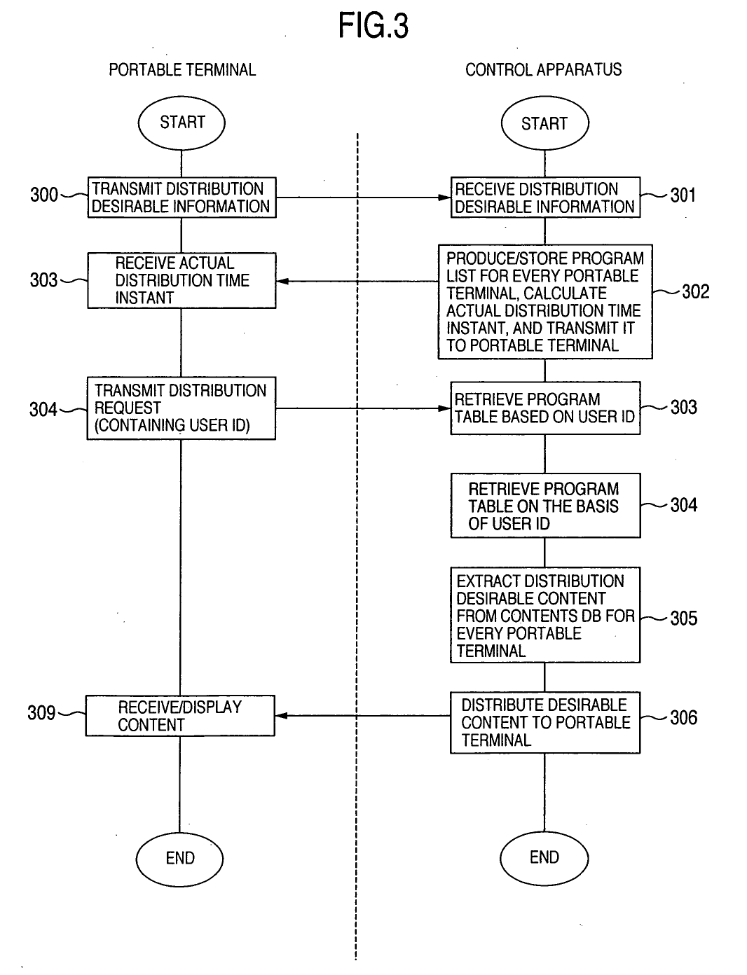

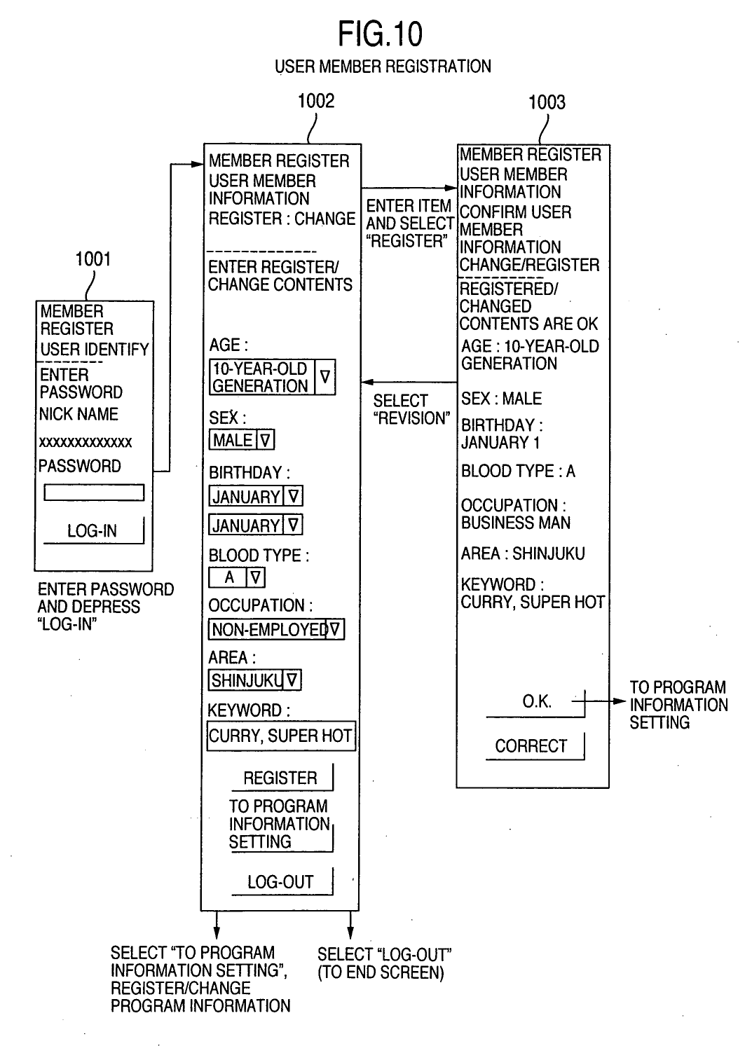

FIG. 3 is a flow chart for indicating a sequential operation example 1 for carrying out the data distributing method. A first explanation is made of a main flow operation of the data distributing method. It is so assumed that a user has perform a user member registration (refer to FIG. 10), and has already become a member for receiving a service provided by the control apparatus 1. The control apparatus 1 acquires user attribute information (sex, age, birthday, occupation, location area etc.) by executing this registration process operation, and then stores the acquired user attribute into the user DB 119. In the case that the control apparatus 1 selects contents and advertisement information for distributing this attribute information to the portable terminal 2 and recommends the contents and the advertisement information to the user side, the control apparatus 1 employs this user attribute information as a base of an attribute matching process operation with the contents, and the like.

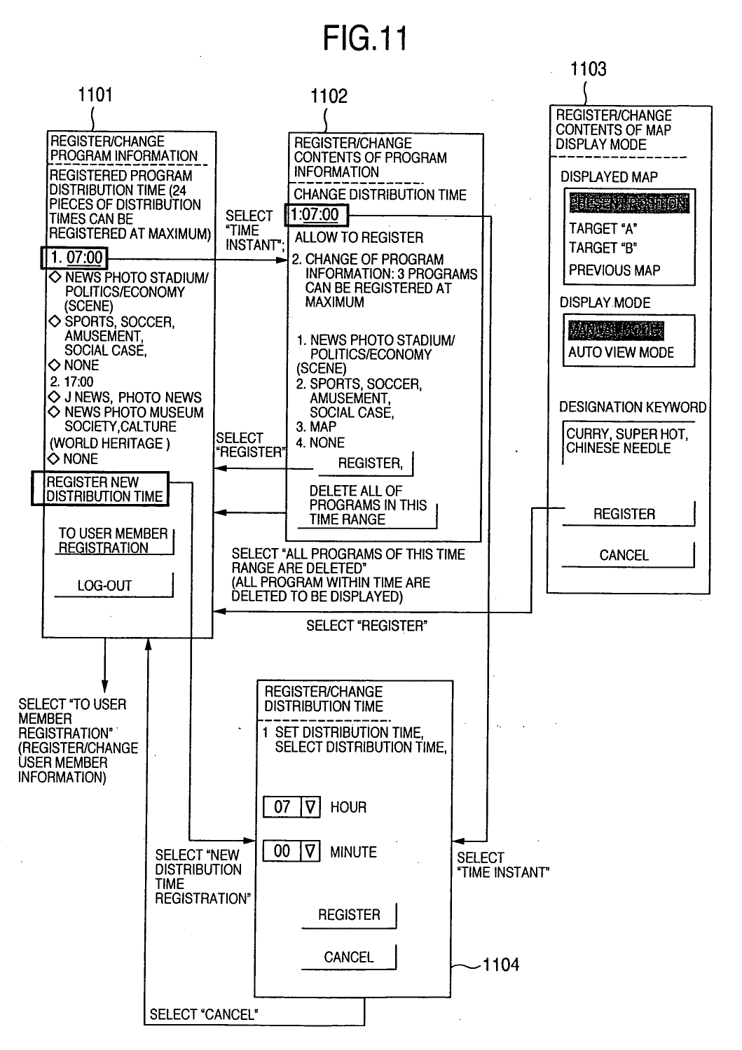

Since the portable terminal 2 is required to produce a program list with respect to the control apparatus 1 prior to a-distribution of the contents, the portable terminal 2 inputs distribution desirable information on, for example, a forming site of the program list provided by the control apparatus 1 (refer to FIG. 11). In this case, as genre of the contents, various sorts of news and photographs such as politics, economy, sports, amusement, and a social field are provided (screen 1101), otherwise, a map (screen 1103) as to a place where a user is located at this time instant may be provided by setting respective distribution times by way of a pull-down menu (screen 1104).

Also, as to the provision of the map data of the screen 1104, the following additional conditions may be applied to the map of the location where the user is present at this time instant, namely, a previously designated mark (landmark) and a previous map are selected; a method for displaying the content of this map is selected; and information which is wanted in this map is designated (for example, is previously designated by keyword).

After the above-explained setting operations have been accomplished, the portable terminal 2 transmits the above-described distribution desirable information to the control apparatus 1 (step S300). The control apparatus 1 receives this distribution desirable information (step S301); produces a program list within a predetermined time period for every user; stores the produced program lists into the program list DB 117; calculates an actual distribution time instant; and transmits the actual distribution time instant within the data of the program lists to the portable terminal 2 (step S302). On the other hand, the portable terminal 2 receives this actual distribution time instant, and stores the received actual distribution time instant into the memory 22 and the like (step S303).

In this case, the above-explained actual distribution time instant indicates such a time instant which is calculated based upon distribution desirable time instant information, and at which a data distribution is actually carried out. For example, in the case that a plurality of users larger than, or equal to a preselected number want to distribute the program list at 12:00, traffics of a network are concentrated in this time range, so that a communication (distribution) operation can be hardly carried out. In this case, an actual distribution time instant may be calculated in such a manner that traffics are distributed within a predetermined time instant range by employing a random number, or may be calculated based upon an order along which distribution requests are received. This predetermined time instant range is defined as, for example, 10 minutes before/after a desirable time instant, or 10 minutes before the desirable time instant and included. This calculating process operation is carried out by the actual distribution time instant calculating unit 106.

In this case, the control apparatus 1 may alternatively store into the user DB 119, such an information that a user permits that a distribution time instant is shifted from a desirable time instant, and an actual time instant, and also, distribution desirable time instant information. Alternatively, the actual distribution time instant may be determined based upon such an item that a plurality of desirable time instants to which priority orders have been given within the predetermined time instant range are received from users. Furthermore, in the step S302, the actual distribution time instant is not calculated, but such a time instant for executing a step S304 where a distribution is required may be alternatively calculated in a similar manner to the above manner. Since the distribution time instant calculated in this manner is owned by the portable terminal 2, the processing load by the control apparatus 1 may be reduced.

Next, the portable terminal 2 transmits a distribution request (including user ID) to the control apparatus 1 at a time instant defined based upon the distribution desirable time instant information (step 304). On the other hand, the control unit 1 receives the distribution request (step S305), and retrieves a program list corresponding to this user from the program list DB 117 based upon the user ID contained in this distribution request (step S306).

Subsequently, the control apparatus 1 specifies a content which has been set at the distribution desirable time instant in the retrieved program list, and then, extracts this specified content from the contents DB 118 (step S307). The control apparatus 1 transmits the extracted content to this portable terminal 2 (step 308), and then, accomplishes the process operation.

On the other hand, the portable terminal 2 receives the content transmitted from the control apparatus 1, and displays the received content on the display (step S309).

FIG. 15 is a flow chart for explaining process operations for calculating an actual distribution time instant (step S302 of FIG. 3). Although the process operations of FIG. 15 are carried out after the process operation of the step S301 shown in FIG. 3 has been carried out, the process operations of FIG. 15 may be alternatively commenced by such an opportunity that the portable terminal 2 transmits an information request of an actual distribution time instant as, for example, a feedback request to the control apparatus 1 (step 1500). The control apparatus 1 receives this feedback request and then, acquires a user ID, a password required to access the control apparatus 1, and distribution desirable time instant information, which are contained in this received request (step S1501).

While the control apparatus 1 utilizes information acquired based upon the feedback request, the control apparatus 1 retrieves and specifies the distribution desirable time instant information and another distribution request for requesting a distribution at the same time range in the program list DB117 (step S1502). The distribution request specified in this step is duplicated in the same time range. As a consequence, the control apparatus 1 judges as to whether or not a total number of these distribution requests becomes larger than, or equal to a predetermined number (step S1503).

In the case that the duplicated distribution requests become larger than the predetermined number, the control apparatus 1 judges as to whether or not a predetermined distribution interval can be maintained (step S1504), for instance, although 6 distributions per 10 minutes (namely, time interval of 2 minutes) constitute the predetermined number, distribution requests larger than, or equal to 7 distributions have already been issued, or a distribution request from the portable terminal 2 becomes a 7-th distribution.

When the distribution interval can be maintained, the control apparatus 1 executes a process operation for changing the actual distribution time instant (step S1505). Thereafter, the process operation is returned to the previous step S1504 in which the control apparatus 1 judges as to whether or not the distribution interval can be again maintained. The process operations defined in both the step S1504 and the step S1505 are repeated until the control apparatus 1 can judge that the distribution interval can be maintained. Then, if the distribution interval can be maintained, then the process operation is advanced to a step S1506. Also, in the case that duplicated distribution requests in the step S1503 is smaller than, or equal to the predetermined number, the process operation is advanced to the step S1506. The process operation for changing the actual distribution time instant implies the following process operation. That is, for example, while a certain user desires a content distribution at 2:00 PM, in such a case that distribution requests are larger than the predetermined number, a distribution time instant is shifted before/after 2:00 PM (for instance, arbitrary time instant between 1:30 PM and 2:30 PM).

In this, the control apparatus 1 determines such a distribution schedule that actual distribution time instants are arranged in response to the respective distribution requests by spacing a predetermined distribution interval in accordance with received orders of distribution requests issued from the respective portable terminals 2. Alternatively, while a random number is generated for every distribution request, the control apparatus 1 may determine such a distribution schedule that actual distribution time instants are arranged in response to the respective distribution requests by spacing a predetermined distribution interval in accordance with large/small relationships between predetermined digits of the random numbers. Otherwise, while predetermined digits of the random numbers are regarded as numeral values of time instants, the control apparatus 1 may determine actual distribution time instants of the respective distribution requests. Anyway, the control apparatus 1 may employ any of the sequential methods if these sequential methods may determine actual distribution time instants in such a manner that contents may be distributed by maintaining the predetermined distribution interval.

The control apparatus 1 transmits the determined actual distribution time instant to the relevant portable terminal 2 (step S1507), and then accomplishes the process operation. It should also be noted that the control apparatus 1 sets this determined actual distribution time instant in the program list DB 117 as a distribution time instant. On the other hand, the portable terminal 2 receives the actual distribution time instant from the control apparatus 1, and stores this received actual distribution time instant into the memory 22 (step S1508).

The actual distribution time instant determined in the above manner is transmitted as a distribution request from the portable terminal 2 with respect to the control apparatus 1. Thereafter, the control apparatus 1 extracts the relevant content from the contents DB 118 based upon the distribution request containing the actual distribution time instant, and transmits the extracted content at the actual distribution time instant.

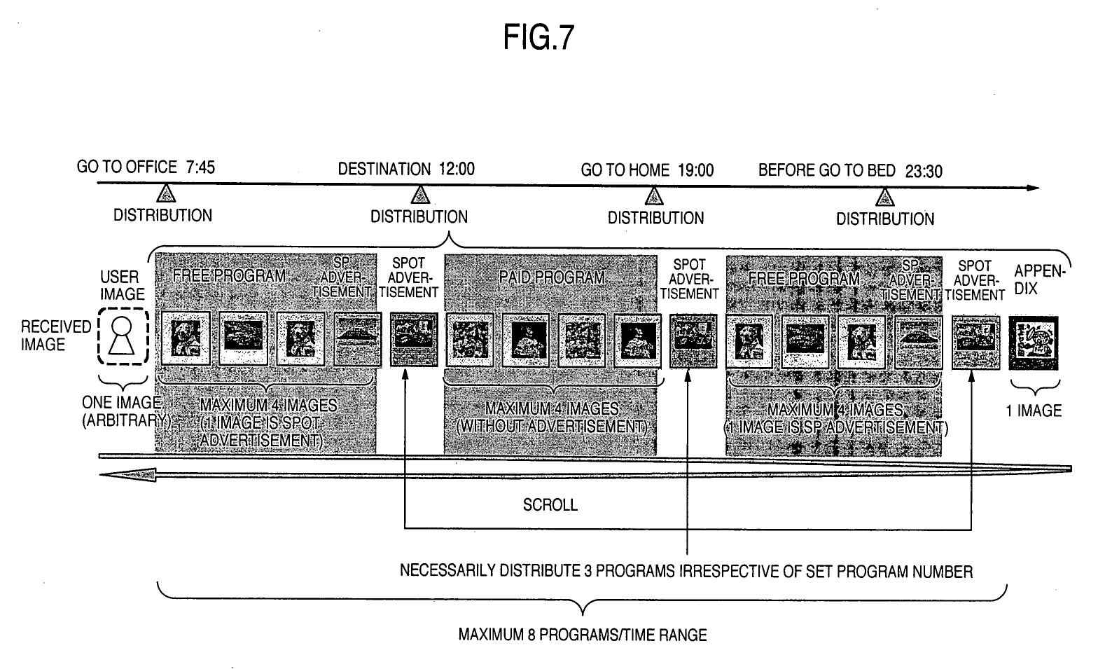

It should also be noted that as an image example capable of viewing a program list, program columns such as television and radio programs may be conceived which are illustratively described on newspaper and magazines. This image example is made of such a display style that distribution time instants are listed in on column, whereas titles of distribution contents at these distribution time instants are described in a parallel manner. Also, as indicated in FIG. 7, as actual operation examples, a distribution content is set by a user in such a time range as “go to office”, “destination”, “return to home”, and “before go to bed.” In this content, 1 program has been constituted by 4 sheets of images in maximum. In this case, an inserted advertisement has been arranged as a spot advertisement at a last portion of each of the programs. Also, in the case of a free program, one image within the four images is used as an image of a sponsor advertisement. Such an operation example may merely constitute one example, and therefore, the operation example may be arbitrarily changed by the control apparatus 1 in response to various sorts of conditions, namely, sizes of contents and advertisement information; specifications and operating conditions of the network 6 and the control apparatus 1. It should be noted that a preselected number of the illustrated spot advertisements may be distributed irrespective of a total number of the set programs, or may be distributed based upon a total number of the set programs. Also, the example of FIG. 7 represents an example of such a program which is distributed before/after 12:00. In this case, the programs from a left end up to a right end are distributed as a series of the programs, and a series of these programs are repeatedly as a scrolled program until next distribution.

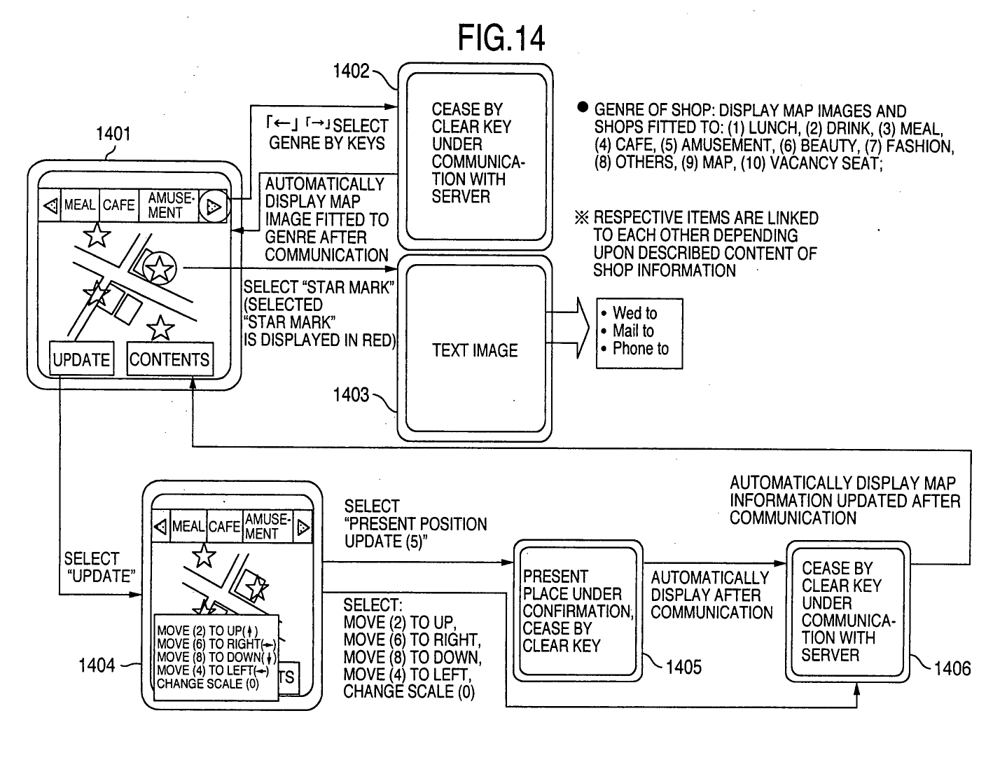

Furthermore, transitions of icon selections may be performed by the following operations. It should also be noted that symbol “UP (⇑)” shown in the below-mentioned explanations may follow an example of FIG. 14.

UP (⇑): An icon is moved to another icon upwardly displayed by one icon on a screen. It should be noted that when an icon is displayed at the uppermost position of the screen, this icon is moved to another icon displayed at the lowermost position.

DOWN (⇓): An icon is moved to another icon downwardly displayed by one icon on the screen. It should also be noted that when an icon is displayed at the lowermost position of the screen, this icon is moved to another icon displayed at the uppermost position.

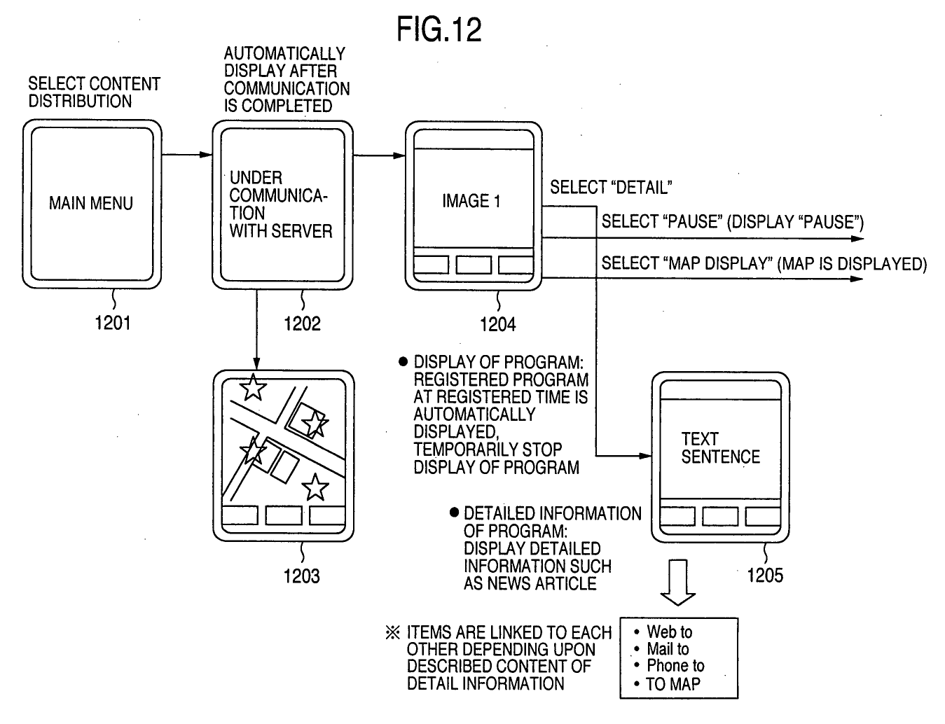

Next, a description is made how to output a content when the portable terminal 2 receives the distribution of this content with reference to a screen transition example of FIG. 12. It is so assumed that the portable terminal 2 instructs to commence a distribution of a content on a screen 1201 of the main menu. At this time, the portable terminal 2 performs a data communication with the control apparatus 1 so as to transmit the own user ID and the information of the distribution time instant to the control apparatus 1 (screen 1202). On the side of the control apparatus 1, the corresponding content is extracted so as to be transmitted to the portable terminal 2 (screen 1204). Otherwise, in the case that a distribution of map data is instructed on the screen 1201, such a map data shown in the screen 1203 has been displayed on the display. While this map data has been stored in the contents DB 118, the map data is extracted and displayed in response to an input of positional information, and an input of a predetermined shop from the portable terminal 2. On this screen 1203, for example, even in such a case that a distribution start instruction button of “content” is depressed, the control apparatus 1 executes a transition to the screen 1202.

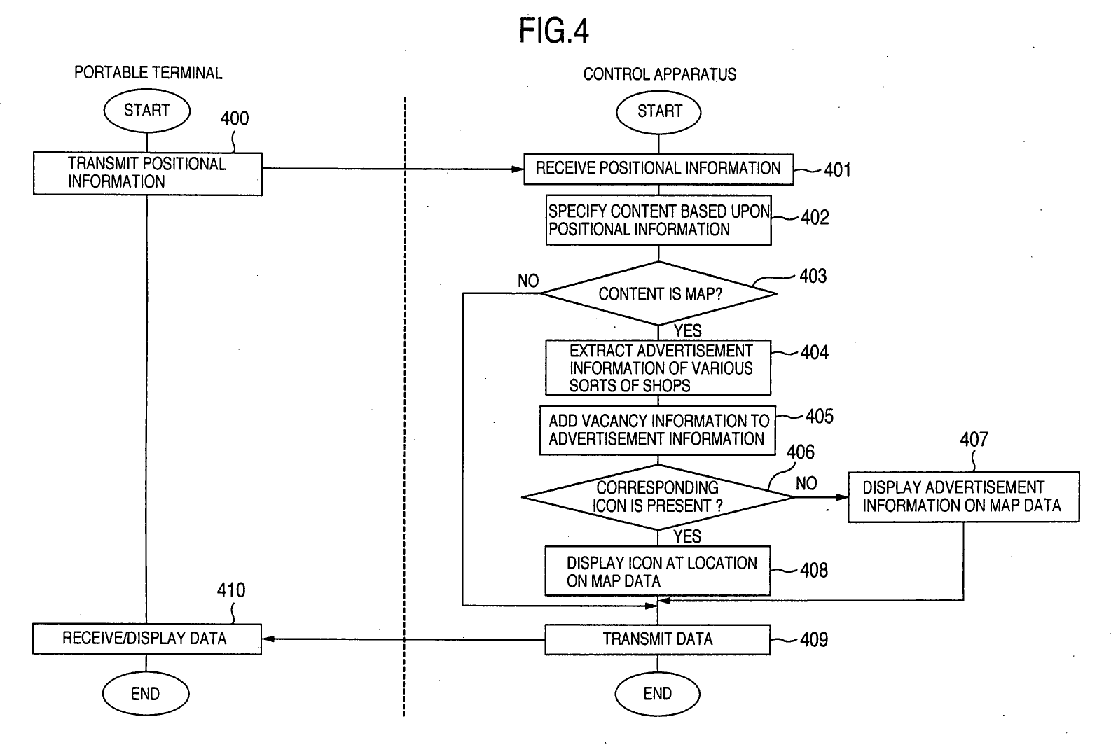

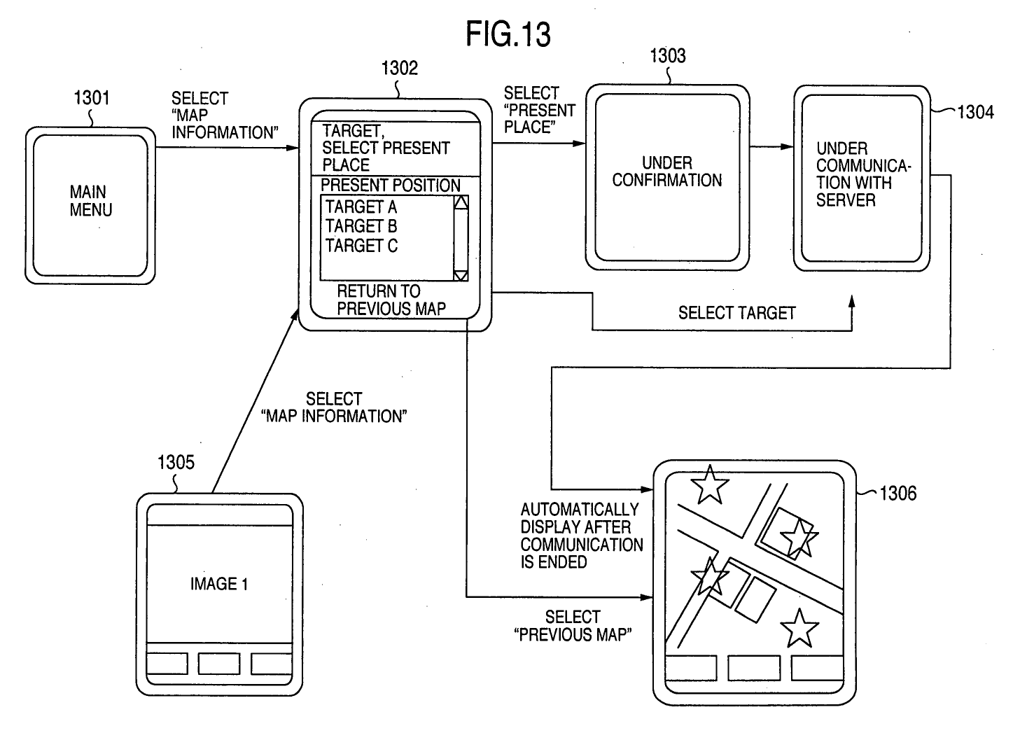

Also, when a content is displayed on the display, the control apparatus 1 executes a temporary stop process operation as to a detailed information (screen 1205) of the content and a scroll thereof by depressing such an instruction button as “PAUSE” and “Detail.” In the case that a URL, a mail address, and a telephone number of a communication destination are contained in the contents of the detailed information, the control apparatus 1 may display command links such as “Mail to”, “Web to”, and “Phone to”, and may accept an instruction for executing a process operation. FIG. 4 is a flow chart for explaining sequential operation example 2 as to the data distributing method. A description is made of a process operation that a content is distributed, and also, distributions of map data and advertisement information can be firmly executed in a higher efficient manner in correspondence with positional information of the portable terminal 2. Firstly, the portable terminal 2 acquires present positional information from the GPS apparatus 23. Alternatively, the portable terminal 2 acquires positional information by receiving an input of a user related to such a temporary location as a travel destination and a business trip destination from the I/F 23. The portable terminal 2 transmits such a positional information to the control apparatus 1 (step S400). As indicated in FIG. 13, instead of the GPS information, since a designation of a mark (station, government office, tall building) whose location has been registered is accepted by the I/F 23, this mark designation may be handled as present positional information.

On the other hand, the control apparatus 1 receives the positional information transmitted from the portable terminal 2 (step 401), and then judges as to whether this positional information corresponds to present positional information indicative of a present position, or temporary positional information indicative of a temporary location by comparing the registered addresses in the user DB 119, and then, specifies a content in response to this judgement (step S402). In the case of the temporary positional information, the control apparatus 1 extracts such a content which is stringed to the positional information in the contents DB 118. In the case of the temporary positional information, the control apparatus 1 extracts either the registered address or the temporary location of the user from the user DB 119, and specifies a content in the contents DB 118 based upon the extracted information.

Next, the apparatus 1 judges as to whether or not the specified content is map data (step S403). In the case that the specified content is not the map data, the control apparatus 1 distributes this specified content to the relevant portable terminal 2 (step S409) and accomplishes the process operation. It should be noted the process step S403 need not be provided. That is, the control apparatus 1 may be controlled in such a manner that the map data may be displayed without any instruction of the user.

On the other hand, when the specified content corresponds to the map data, the control apparatus 1 extracts advertisement information as to various sorts of shops which are located in an area indicated by the map data from the advertisement DB 120 (step S404). This process operation may be executed by retrieving from the advertisement DB 120, such advertisement information to which the positional information matched with the data of the “positional information” column of the content has been stringed.

Next, the control apparatus 1 adds information (vacancy seat information, and discount information of goods and services) which has been previously received from the shop terminal 3 to the advertisement information as to the information corresponding to such a shop which solicits business by employing the extracted advertisement information (step S405).

Next, the control apparatus 1 judges as to whether or not the corresponding icon is present in the extracted advertisement information (step S406). This icon is such an image data to which an acquisition request command of the advertisement information has been related, and for instance, conditions which correspond to each of the advertisement information and stored may be supposed. As a consequence, if the control apparatus 1 investigates as to whether or not such an icon stringed to advertisement information is present in the advertisement DB 120, then the control apparatus 1 can execute the process operation of the step S406.

When the corresponding icon is not present in the step S406, the control apparatus 1 executes such a process operation for directly displaying the advertisement information on the map data (step S407), and distributes the processed advertisement information to the portable terminal 2 (step S409), and then, accomplishes the process operation.

On the other hand when the corresponding icon is present, the control apparatus 1 executes such a process operation that the icon which is related to the acquisition request command of the advertisement information is displayed on a location of the relevant shop on the map data (step S410), and distributes the processed icon data to the portable terminal 2 (step 409), and then, accomplishes the process operation. It should be understood that a process operation of a step S410 also contains the below-mentioned process operations:

(1) Information corresponding to each of the plural icons (at least a portion thereof) which are represented as a representative icon is displayed on a predetermined position on a screen.

(2) Each of the plural icons (at least a portion thereof) which are represented as the representative icon is separately displayed. In this case, these icons may be alternatively displayed in such a manner that overlapped icons are decreased by changing a scale of a map, or by changing dimensions of the icons themselves.

As another example of he icons, one representative icon to which the acquisition request commands of the advertisement information of the respective shops are related may be supposed as to the shop groups which are grouped at a location within a predetermined range. Also, in this case, the control apparatus 1 performs such a process operation that this representative icon is displayed on the location of the map data, and distributes the processed icon data to the portable terminal 2.

On the other hand, the portable terminal 2 receives such data that the map data, the icons and the representative icon distributed from the control apparatus 1 are combined with each other, and displays the received data on the display (step S410). As to a screen image at this time, for instance, such an image is displayed as the screen 1306 of FIG. 13.

It should also be noted that a view history of map data may be included in the information of the view history in the user DB 119 of FIG. 2C. In such a case, the control apparatus 1 recognizes an attribute of map data (for instance, relevant area indicated by map data, and move route in such a case that map data is continuously viewed) contained in the view history, and may execute such a process operation that at least any one of contents, map data, and advertisement information corresponding to this attribute is extracted from the contents DB 118 and the advertisement DB 120, and then, distributes the extracted item to the portable terminal 2.

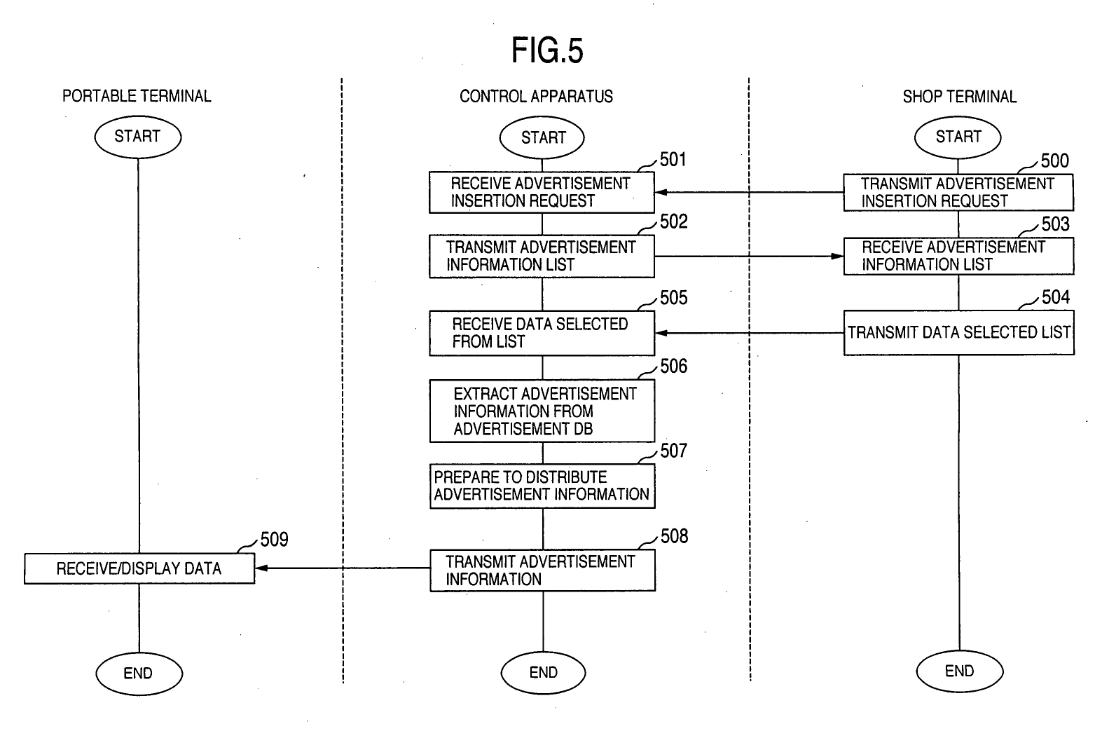

FIG. 5 is a flow chart for explaining a sequential operation example 3 as to the data distributing method. A description is made of a process operation that advertisement information which is added to a content is replaced and amended. Firstly, a request for replacing advertisements, or for partially amending an advertisement related to the own shop is transmitted from shop terminal 3 to the control apparatus 1 (step S500). The control apparatus 1 receives this request (step S501), and produces an advertisement information list which has been registration-examined and has been stored in the advertisement DR 120, and then transmits this produced list to the shop terminal 3 (step S502).

This advertisement information list corresponds to such a list of advertisement information which is judged by a system manager that this advertisement information list has no problem in the light of, for example, an advertisement ethical rule even when these advertisements are publicly disclosed. On the other hand, since it is practically difficult to quickly examine a very large number of advertisement information in real time, for example, a plurality of advertisement information are previously examined for every ship terminal 3 and then, only such advertisements which can pass the examination are held as the list by the control apparatus 1.

For instance, as shown in FIG. 2D, in an advertisement content column of the advertisement DB 120, as to underlined phrases, these phrases are linked to a pull-down menu of a goods list and a discount rate list of the relevant shop; and then, goods names and discount rates (which could pass registration examination) which constitute the phrases of the advertisement information can be freely selected on the side of the shop terminal 3. Since such a process operation is executed by the control apparatus 1, an advertisement strategy which is considered by the shop side in correspondence with actual results of advertisement results and weather may be directly accepted.

The shop terminal 3 receives the advertisement information list transmitted by the control apparatus 1 (step S503), and then, the data selected from this advertisement information list is transmitted to the control apparatus 1 by a user, or the like of the shop terminal 3 (step S504).

The control apparatus 1 receives the selected data from the shop terminal (step S505), and extracts the relevant advertisement information from the advertisement DB 120 (step S506). Then, the control apparatus 1 selects such contents that the advertisement information extracted in this step is matched to an attribute, and performs a distribution preparation for confirming distribution time instants of both contents (step S507). When the distribution preparation is completed, the control apparatus 1 distributes the advertisement information to the portable terminal 2 (step S508), and then, accomplishes the process operation.

On the other hand, the portable terminal 2 receives the advertisement information and displays the received information on the display (step S509).

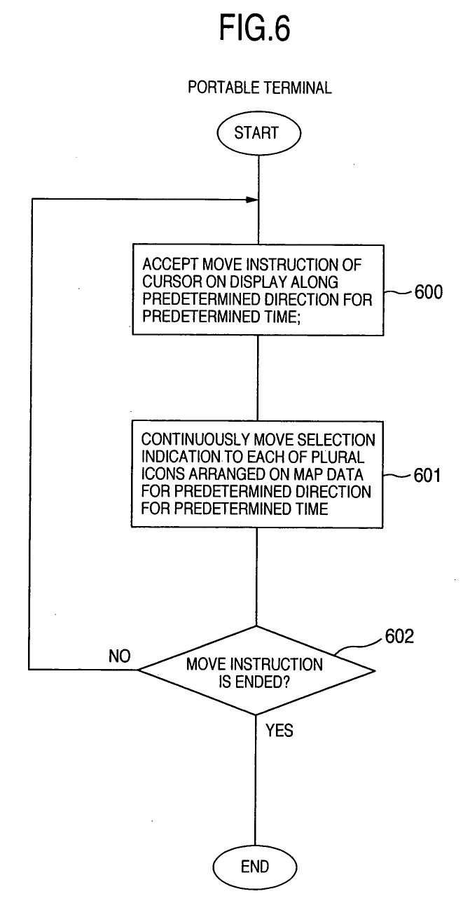

FIG. 6 is a flow chart for explaining a sequential operation example 4 as to the data distributing method. A description is made of a technical idea that a contents operability displayed on the portable terminal 2 may be improved. First of all, the following case is supposed: That is, a content distributed from the control apparatus 1 to the portable terminal 2 corresponds to such a map data that icons stringed to acquisition request commands of advertisement information as to various sorts of shops are displayed on a predetermined location of the relevant shop. At this time, the portable terminal 2 accepts from the I/F 23, such an instruction for moving a cursor displayed on the display along a predetermined direction for a predetermined time (step S700).

Next, the portable terminal 2 continuously moves a plurality of icons arranged on the map data, and a selective display to a representative icon along the predetermined direction for the predetermined time (step S701). This process operation is repeated until the move instruction is completed. After the move instruction has been ended, the process operation is accomplished.

Concretely speaking, for example, as shown in FIG. 14, cursor keys (arrow key and predetermined numeral key) of the portable terminal 2 correspond to predetermined directions (forward/backward/right/left directions), and selections of icons and a representative icon on the display are continuously moved in conjunction with a depression time (predetermined time) of any one of these cursor keys. For example, as to the continuous movement, while the “downward” cursor key is depressed, an icon selection is moved from an icon displayed on the upper portion of the display toward such an icon located within the shortest distance (irrespective of right/left positions). Also, a coordinate system where icons are displayed may be discriminated, and then, an icon selection may be alternatively sequentially moved from an icon located near a predetermined position. For example, an icon may be alternatively moved from an upper left position on the screen to a lower right position on the normal display.

It should also be noted that the control apparatus 1 may be alternatively equipped with such a program. That is, while the map data itself receives a move instruction of a cursor indicated on the display along a predetermined direction for a predetermined time from the portable terminal 2, the plural icons and the representative icon arranged on the map data are continuously moved along the predetermined direction for the predetermined time.

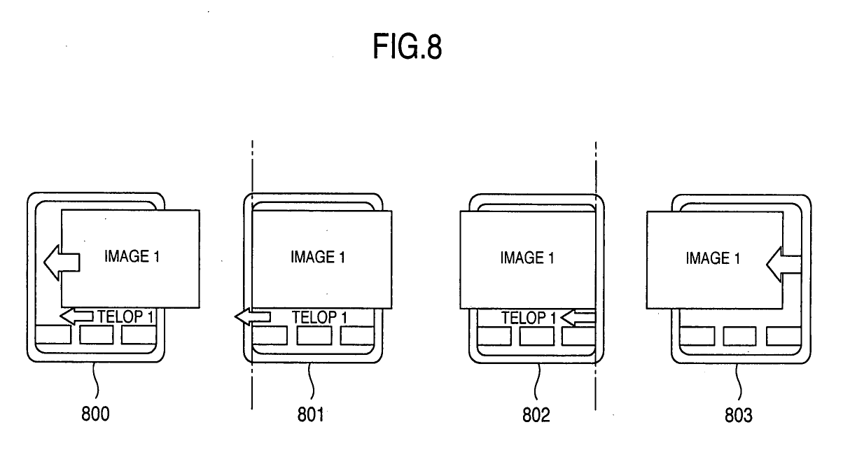

FIG. 8 is a diagram for indicating an image as to scroll control operation of a content. A description is made of a technical idea capable of improving visibility as to an icon which is automatically displayed on the display. As one example, the content is distributed from the control apparatus 1 to the portable terminal 2, and thereafter, this icon is scrolled along a predetermined direction to be displayed on the display. At this time, the below-mentioned problems may be conceived. That is, if the scrolling speed becomes too fast, then this content can be hardly viewed by the user. Conversely, if the scrolling speed becomes too slow, then the user ceases to view the content since the user cannot endure redundant process operation.

As a consequence, the portable terminal 2 scrolls the content distributed from the control apparatus 1 at a speed higher than, or equal to such a speed that one end of this content may be reached from one end of the display to the other end thereof within a predetermined time (refer to screens 800 and 801). Also, the portable terminal 2 scrolls this content within such a speed that after one end of the content has been reached to the other end of the display, the other end of the content may be reached to the other end of the display for a time longer than, or equal to the predetermined time (refer to screens 802 and 803).

It should also be noted that the content itself may be provided with a program for scrolling this content at a speed higher than, or equal to such a speed that one end of this content may be reached from one end of the display to the other end thereof within a predetermined time, and another program for scrolling this content within such a speed that after one end of the content has been reached to the other end of the display, the other end of the content may be reached to the other end of the display for a time longer than, or equal to the predetermined time (refer to screens 802 and 803).

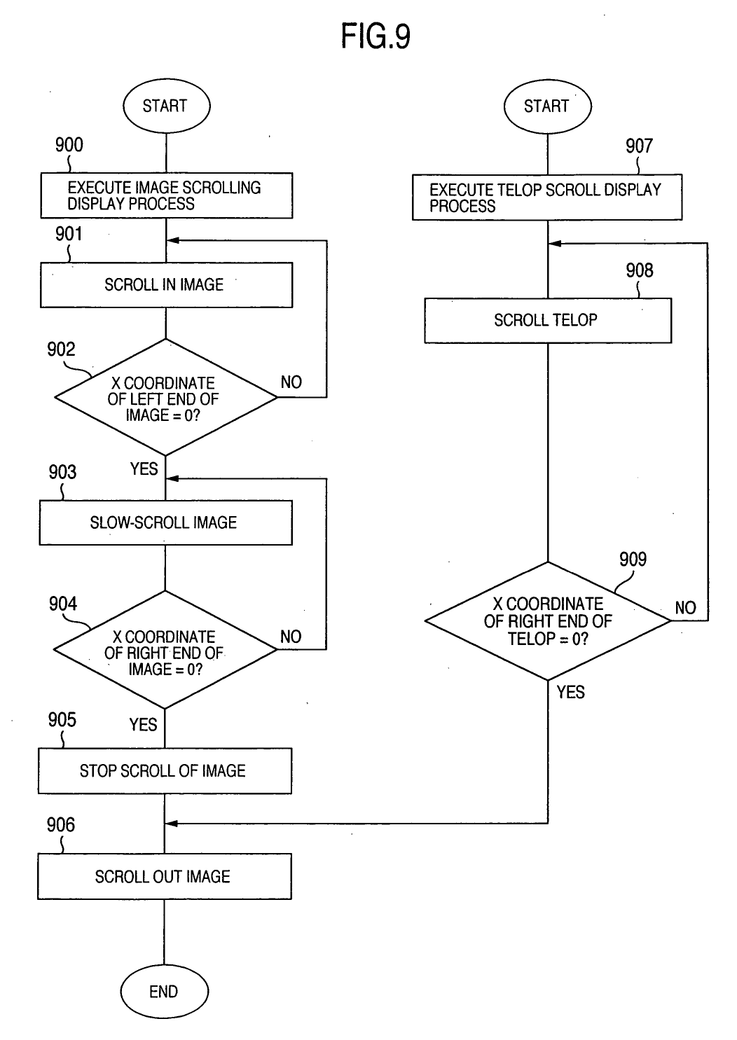

FIG. 9 is a flow chart for showing a sequential operation example 5 as to the data distributing method. It should be noted that a character portion within advertisement information will be referred to as a “telop” hereinafter.

The portable terminal 2 firstly starts a process operation for scroll-displaying both an image and a telop at the normal scrolling speed (steps S900 to S902). The portable terminal 2 judges as to whether or not an X coordinate (corresponds to dot number of image) as to a left end of the image is equal to “0” (step S902). When the X coordinate as to the left end of the image is not equal to “0” in the coordinate on the screen of the display, the process operation is returned to the previous step S901. On the other hand, when the X coordinate as to the left end of the image is equal to “0” in the coordinate on the screen of the display (namely, in such a case that left end of image has been reached to the other end of display), the portable terminal 2 executes a process operation for lowering a scrolling speed of the image (will be referred to as “slow scroll” hereinafter) (step S903).

This slow scroll is continued until an X coordinate as to a right edge of the image becomes “0” (step S904), and then, if this X coordinate becomes “0”, then the slow scroll is stopped (step S905). On the other hand, as to a scrolling process of the telop, if an X coordinate as to a right end of this telop becomes “0”, namely, if the telop is scrolled out, then the image is also scrolled out (step S906), and the process operation is ended. After both the image and the telop are scrolled out, the portable terminal 2 scrolls in both a next image and a next telop.

It should also be understood that as a concrete example as to speeds of scrolling process operations, the following scrolling speeds may be conceived: The normal scroll of an image is 20 dot/30 ms (until screen is scrolled to left end); the slow scroll of the image is 1 dot/30 ms (after screen has been scrolled to left end); and the scroll speed of a telop is 3 dot/30 ms. In this case, the portable terminal 2 executes a drawing process operation as to the content and the like in the unit of 30 ms.

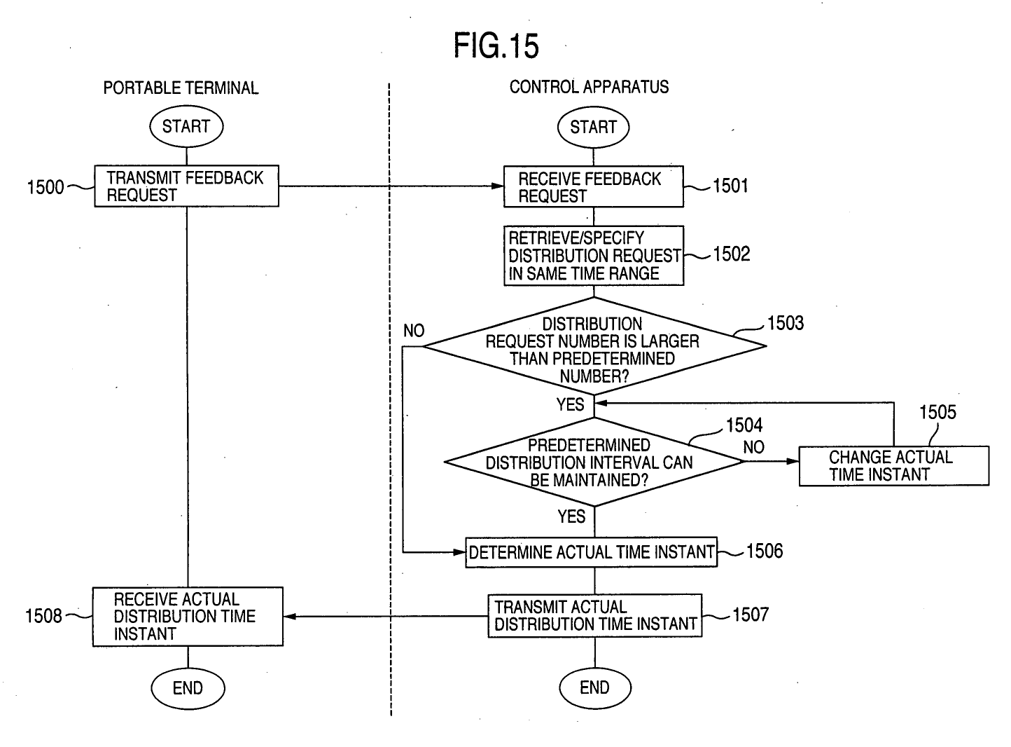

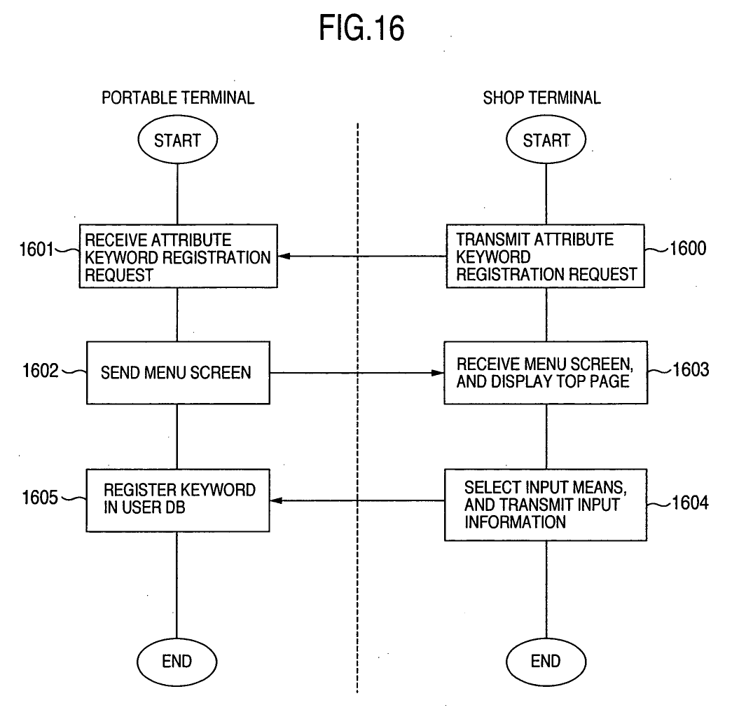

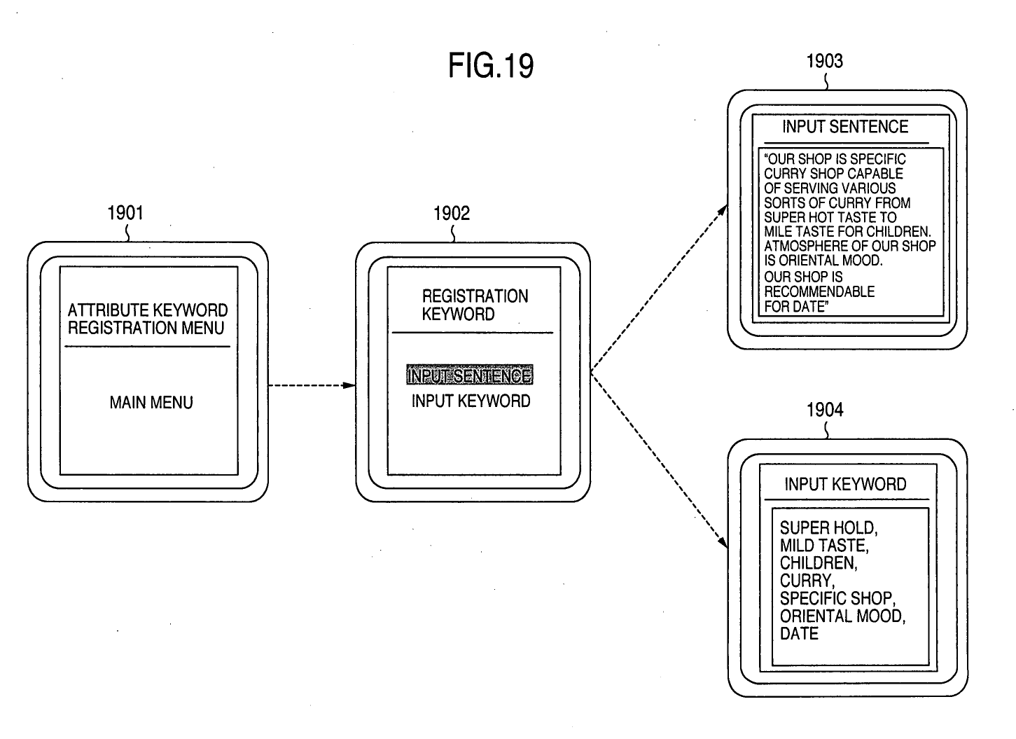

FIG. 16 is a flow char for indicating a process operation for registering a request attribute keyword which is employed in order that an attribute of a user who is wanted to be conducted by a shop is registered. FIG. 19 illustratively shows display content in the case that a portable telephone is employed as one of the shop terminal 3. The shop terminal 3 may be alternatively realized by a PC (Personal Computer), or the like.

Firstly, the shop terminal 3 requests the control apparatus 1 to register an attribute keyword (step S1600). When the control apparatus 1 receives this registration request from the shop terminal 3 (step S1601), a menu screen is transmitted from an attribute keyword input I/F providing unit 115 to the shop terminal 3 (step S1602). The shop terminal 3 displays a top page of this menu (step S1603). When data is inputted by a user of the shop terminal 3, the input information is transmitted to the control apparatus 1 (step S1604). As the input method, there are a keyword input and a sentence (message in which keywords are mixed) input (refer to screen 1902 of FIG. 19). When the keyword input method is selected, this keyword is indicated on the screen 1904. When the sentence input method is selected, this sentence is indicated on the screen 1903. When the keyword input is made, the control apparatus 1 registers the keyword in the record of the request attribute keyword (refer to FIG. 2D) of the user DB 119, whereas when the sentence input is made, the control apparatus 1 segments the sentence to obtain words in the attribute keyword input I/F providing unit 115, and performs a similar process operation to the above-explained process operation (step S1605).

It should also be understood that as a process operation for segmenting a sentence into words, and a retrieving technique based upon a word, the all sentence retrieving system Namazu is known as well-known software (http://www.namazu.org/index.html.en).

In this case, a description is made of “real-time message exchange in interactive manner while calling is used as chance” which corresponds-to an effective customer conducting method in a real world.

(1) The expression “real-time message exchange in interactive manner while calling is used as chance” corresponds to one mode of communications established between a shop staff of a shop and potential customers (users) who are present near this shop. A content of “calling” action is for example, an appeal of goods owned by this shop, and such an announcement that this goods is low price.

(2) The action “calling” is selectively performed by the shop staff of this shop in response to an attribute of a user. For instance, the shop staff calls a purchase of cosmetics to a female, and a purchase of toys to children.

(3) The action “calling” is temporarily performed at a limited place, and is completed by that the user purchases the goods, or the user leaves from this shop. After the completion, the shop staff and the user are recovered to an unrelated personal relationship. As a consequence, the personal information of this user is not disclosed.

(4) The user also selectively responds to “calling” action. The user instantaneously understands a content of an advertisement contained in this “calling” action, and judges as to whether or not the user responds thereto. As previously explained, if this advertisement content is interesting, then the user may accept the communication temporarily established at the limited place. For instance, the user makes a question as to this advertisement content, and conducts concrete information as to the goods from the shop staff of the shop, or negotiates a price of the goods.

Generally speaking, in a client server type virtual shop using the Internet and the like, although a user can visit this virtual shop by entering a URL of the shop to a Web browser, or by accessing a server installed in the shop via linked information, a converse accessing method cannot be established.

On the other hand, there is another method for instance, spam mail method for conducting user accesses to the server on the shop side by using a large amount of mail addresses which have been previously acquired. This accessing method owns a merit for the shop side that an advertisement can be mailed in a relative manner, but owns a demerit for the user side that the user must receive, read, and delete an unnecessary advertisement, namely cumbersome works. Therefore, the user may have ill feelings with respect to the shop, which is not desirable in view of the customer conducting effect in a higher efficiency.

Also, in the spam mail system, spam mails are transmitted at timing decided by the shop side, whereas the send spam mails are read at timing decided by the user side, which cannot realize such a “calling” type customer condition which temporarily performed at a limited place.

Furthermore, in the present Internet system, in the “call” action, the shop side cannot select users. Even if this user selection is available, the user cannot select as to whether or not a response is made to this “calling” action.

In the present Internet virtual shops, users can visit these virtual shops while maintaining anonymous characteristics. However, in such a case that a user is actually communicated with a shop, this user can hardly visit this shop while keeping anonymous characteristics. This reason is given as follows: In the Internet, IDs such as mail addresses capable of specifying user information are disclosed, so that communications can be established.

If an ID is once disclosed, this disclosed ID is used even after “real-time message exchange in interactive manner while calling is used as chance” has been completed. Therefore, there are some possibilities to disturb that both the user and the shop are returned to the perfect unrelated personal relationship.

For example, in the case that a user inquires goods information by using an electronic mail with respect to a virtual shop in the Internet, in order to receive an answer from this shop, the user must disclose the own ID such as an E-mail address. However, if such an ID is once disclosed, then this disclosed ID is transferred to a third party, so that this transferred ID is used for other purposes (for example, unnecessary advertisement mail is transmitted) than the inquiry of the goods information. To avoid this problem, such a method has been disclosed (see JP-A-2004-342127) which provides an electronic mail server system capable of transmitting/receiving electronic mails while keeping anonymous conditions between both parties. This electronic mail server system is provided with a means for designating a transmission source address during mail transmission while remaining anonymous; in the electronic mail server, a mail whose transmission source address is designated in secret is judged, the transmission source address is converted into an anonymous address, and further, as to a response mail returned with this anonymous address, this anonymous address is restored to the transmission source address which is designated in secret. However, although the messages can be exchanged without specifying the user, since the anonymous address itself is repeatedly used, there are some possibilities that such a function capable of specifying an individual may be achieved.

An anonymous mail is employed in order to transfer information under such a condition that personal information is completely hidden. However, since an anonymous ID is continuously used, there are some possibilities that an attribute of a user of this anonymous mail may be recognized. Even when a name and an age of this person are unknown, if a taste of this person can be predicted, then no one can deny such a possibility that spam mails are sent to the person having this anonymous mail.

On the other hand, on the side of shops, a service provider and a shop, which wish to distribute individual advertisement mails to respective users, cannot transmit effective advertisement mails if the individuals cannot be specified irrespective of such a condition as to whether or not anonymous characteristic is present.

However, in this embodiment, while personal information is not disclosed, the shop side can be communicated with the users under dynamic environment where the users walk in the actual field.

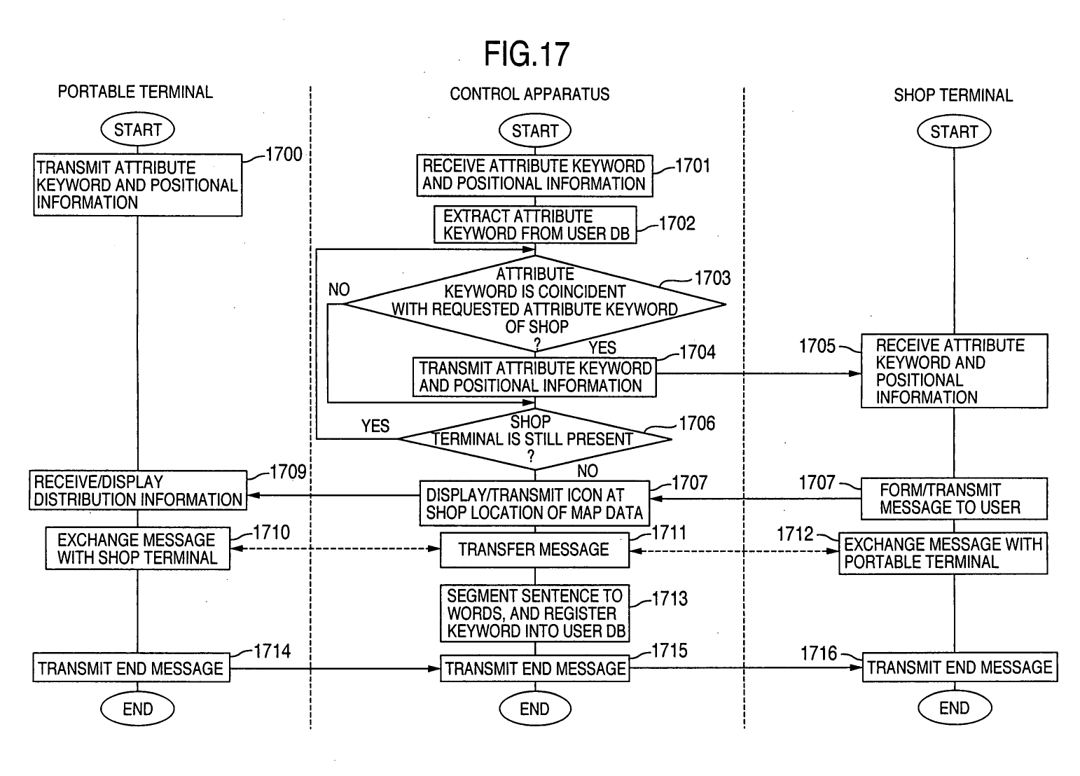

FIG. 17 is a flow chart for explaining such a process operation that a user directly exchanges a message with a shop while “call” action between the portable terminal 2 and the shop terminal 3 is used as a chance.

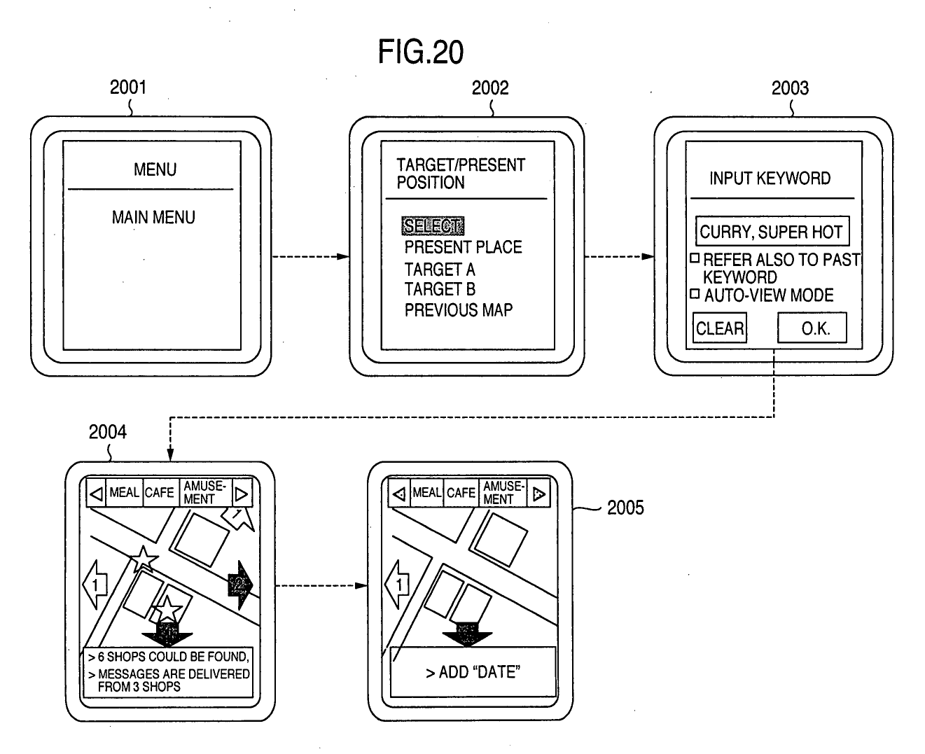

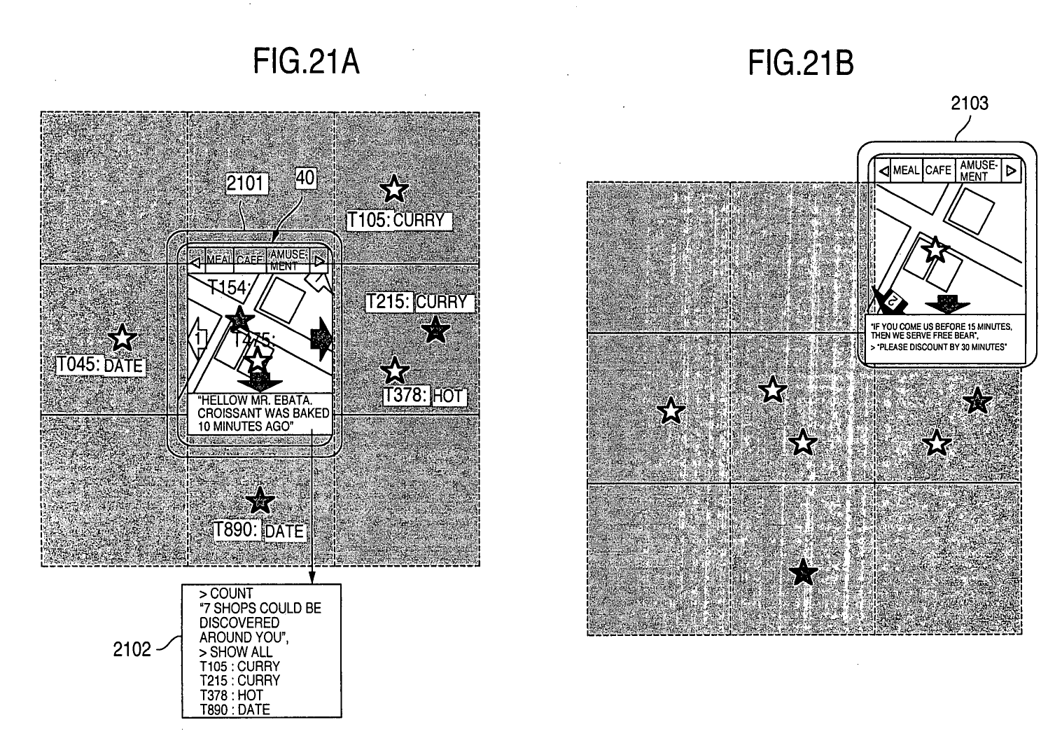

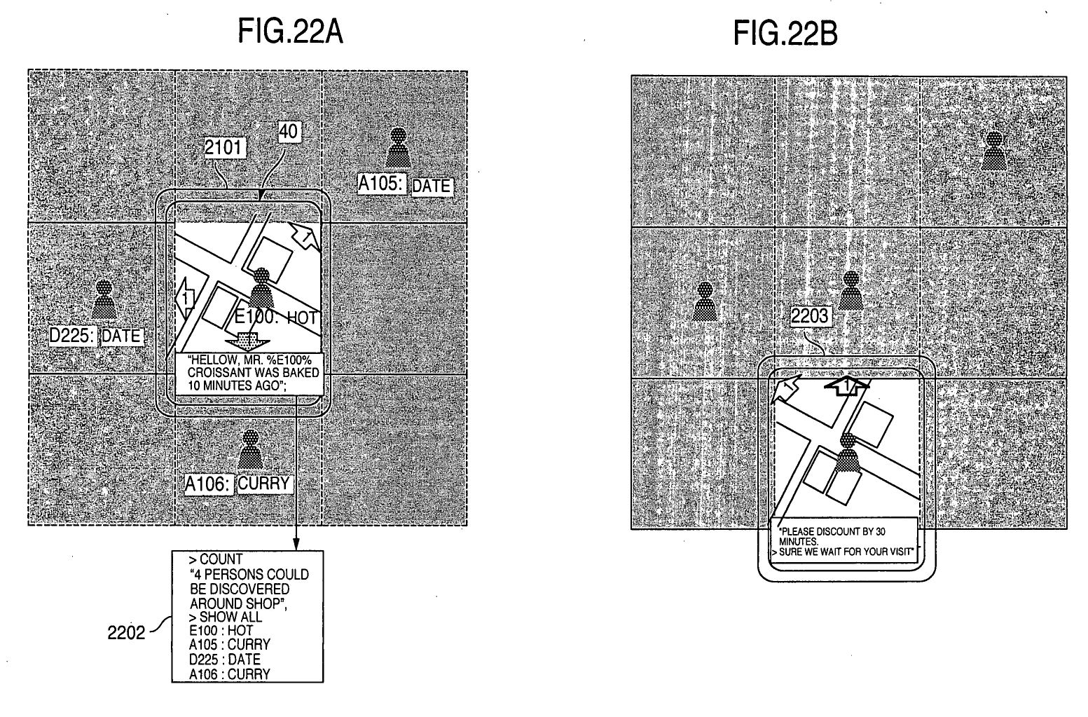

FIG. 20 and FIG. 21 indicate screens of the display in the case that the portable terminal 2 is employed. FIG. 22 shows a screen of the display in the case that the portable terminal 2 is used as the shop terminal 3.

As indicated in the screens 2001 to 2003 of FIG. 20, when the portable terminal 2 transmits both positional information of the portable terminal 2 and an attribute keyword of a user (alternatively, attribute keyword of user need not be used) to the control apparatus 1 (step S1700), the control apparatus 1 receives these information (step S1701), and extracts this keyword from the user ID 119 (step S1702), and then extracts one of shops which are located in the map data and the peripheral area (see FIG. 21A). Then, the attribute keyword matching unit 114 compares the extracted keyword with such a requested attribute keyword stringed to this shop from the advertisement DB 120 (step S1703). When these keywords are made coincident with each other, a virtual address of the user is produced by the temporal user ID producing/distributing unit 112, and is transmitted to the relevant shop in combination with the positional information of the user and the extracted attribute keyword (step S1704), and then, the shop terminal 3 receives these information (step S1705). The control apparatus 1 executes these process operations with respect to all of the shop terminals 3 (step S1706). In the case that these keywords are not made coincident with each other, the process operation is advanced to the step S1706 without via the steps S1704 and S1705. Thereafter, the control apparatus 1 is brought into a waiting status for waiting a message which is produced by the shop terminal 3 to be sent to the user. Although the expression “peripheral area” will be explained as indicating 8 directions (namely, upper, lower, right, left, upper left oblique, upper right oblique, lower left oblique, and lower right oblique directions), this expression is not limited only to 8 directions.

Instead of such an operation that the shop terminal 3 forms the message and sends this message to the user (step S1703), this shop terminal 3 may send an automatic answering message recorded in the advertisement DB 120 described in FIG. 2D in response to a request from this shop. For example, in the case that the attribute keyword of the user is “very hot”, the shop terminal 3 resends such an answering message “Now on curry fair.” As previously explained, since the automatic answering messages have been registered, the shop side can omit such a cumbersome operation that the answering messages are formed with respect to the respective users from the shop terminal. Alternatively, the process operations defined in the steps S1705 and S1706 may be executed by the automatic answering unit 303 of the shop terminal 3.

Furthermore, the shop side may alternatively execute both the automatic answering operation and the manual answering operation in a parallel manner. For example, in the case that keywords (will be explained later) are completely coincident with each other, while the shop terminal 3 performs the manual answering operation with respect to users who own higher matching evaluation functions, the shop terminal 3 performs the automatic answering operation with respect to users other than the above-explained users. As a result, the shop terminal 3 can perform the answering operation with respect to the potential customer with a top priority, and can quickly call the plural customers-at the same time.

It should also be understood that as to this keyword matching method, the below-mentioned matching methods for checking as to whether or not the keywords are identical to each other have been described with respect to conceptional retrieve, resemblant retrieve, vague retrieve, and the like: (1) Ingwersen, Peter: Information Retrievel Interaction, London, Taylor Graham Publishing (1993), (2) Salton, Gerald: Automatic Text Processing, Massachusetts, Addison-Wesley publishing company (1988), (3) Luhn, H. P: A Statistical Approach to Mechanized Encoding and Searching of Literary Information, IBM Journal of Research and Development, Vol. 1, No. 4, pp. 309-317 (1957).

The screen 2004 of FIG. 20 displays that a shop is selected by a keyword. On the screen 2005, since [add “date”] is inputted, a keyword is further added so as to be again retrieved.

A screen 2203 of FIG. 22A displays such a case when the shop terminal 3 receives the information of the step S1705 from the control apparatus 1. As a result, also on the side of the shop terminal 3, both map data where the position of the shop is located at a center thereof, and a position of a user having a higher customer conducting effect and discovered within a peripheral area thereof can be displayed on this screen 2202. An arrow icon and a numeral described in this arrow icon of the screen 2202 represent such a condition that one user is present on the map while the position of the shop is located at the center, and one user is discovered along the upper right oblique direction, the left direction, or the lower direction, which are not represented on the screen of the shop terminal 3. The user of the shop terminal 3 jumps over this arrow icon by using the I/F 33 of the shop terminal 3, and since a predetermined key is depressed on this icon, this user can jump over a peripheral map as shown in on the screen 2203 of FIG. 2B. It should also be noted that these map data may be freely changed in response to a scale of a map designated by the user. Alternatively, an attribute keyword where this user is discovered may be displayed in combination with the provisional ID near the user icon. Furthermore, in combination with the system for displaying the position of the user, while an interactive type interface (screen 2202) is employed, a total number of users who are using the services around the shop, and attribute keywords where these users are discovered may be alternatively displayed in combination with provisional IDs.

Furthermore, in response to matching degrees of keywords, display methods of user icons and shop icons may be alternatively changed. For example, when keywords are completely made coincident with each other, icons may be emphasized by being displayed in a red color, or in a flickering manner, whereas in the case that icons are matched with each other by way of the conceptional retrieve, the resemblant retrieve, and the vague retrieve, the colors and display methods may be changed in response to a value of this matching evaluation function.

The shop terminal 3 forms a message with respect to a user based upon the data received in the step S1705, and transmits the message to the control apparatus 1 (step S1707).

When the control apparatus 1 receives the message from the shop terminal 3, the control apparatus 1 displays icons and a representative icon, which are stringed to the acquisition request command of the advertisement information on this shop location of the map data, and then, transmits these icon information to the portable terminal 2 (step S1708), and the portable terminal 2 receives this distribution information so as to display the received distribution information (step S1709). When a message is again delivered from the shop terminal 3, the control apparatus 1 resends this message to the portable terminal 2, and then, the portable terminal 2 receives this distribution information so as to again display it.

On the screen 2201 of FIG. 22A, such a message “Hello, MR. % E100%. croissant was baked just 10 minutes ago” is displayed which is transmitted by the shop terminal 3 to the user. Since the shop terminal 3 utilizes such an ID “E100” which has been previously sent by the control apparatus 1, the message can be formed. This ID is produced by the temporary user ID producing/distributing unit 111 of the control apparatus 1, and this produced ID is discarded after a predetermined time has passed, or the user is left from the existing area.

A screen 2101 of FIG. 21A indicates such a condition that a message from the shop terminal 3 is displayed. Since the user selects one of the selected icons, the user can read this message. On this screen 2101, such a message is displayed, namely, “Hello, MR. EBATA. croissant was baked just 10 minutes ago.” The message check unit 113 of the control apparatus 1 converts such an ID “EL100” into an actual user name of “EBATA.”

In FIG. 17, the flow operation describes that the message of one shop terminal 3 is transferred to the portable terminal 2. However, the control apparatus 1 continuously receives messages directed to the users from a plurality of shop terminals 3 until a series of process operations are accomplished, and continuously transfers the received messages to the portable terminal 2.

The user can respond with respect to this message. The portable terminal 2 can transmit/receive the message with respect to the shop terminal 3 in a real time, and the control apparatus 1 handles the transfer operation of this message (steps S1710 to S1712). In this case, the control apparatus 1 checks contents of messages by the message check unit 113 in such a manner that an improper message is not transmitted from the shop terminal 3 to the portable terminal 2, or the personal information of the user is not disclosed from the portable terminal 2 of the user to the shop.

In this case, the above-described improper message contains a message which violets a public rule, and a message which is very impolite to a user. Such messages are checked in a real time by a Japanese all sentence retrieving system in the message check unit 113 by employing previously registered words. As a result, the following process operation may be conceived. That is, the distribution of this message having the problem is stopped, a message for indicating this problem is added thereto, and the resultant message is resent to the shop terminal 3. Alternatively, a manager of a system may directly read the relevant message, if required.

On the other hand, a message sent from the portable terminal 2 to the shop terminal 3 corresponds to such a message that a personal telephone number is described therein. In the case that a user expressed his intention that such a check is not required when the user member registration was performed, the above-explained process operation is no longer required.

The attribute keyword input I/F providing unit 115 segments a sentence of a message under exchange-status into words; and registers a keyword in the user DB 1119 (step S1713). Since such a process operation is carried out, an attribute of a new user can be acquired.

Since the user brings a display icon of a shop in an active state, the user can read a message made by the-shop and can exchange messages with respect to this shop. In order to clearly indicate that the shop performs a “calling” action with respect to the user, such an idea as shown in the screen 2101 of FIG. 21A is introduced. That is, in the case that the message has been delivered from the shop side, the icon of this shop is turned ON in a flicker mode, whereas when the icon of this shop is not indicated on the display of the portable terminal 2, the arrow icon is turned ON in the flicker mode, which is used to move to the map data and a peripheral area. As a result, this flickering indication can notify the shop which is performing the “calling” action to the user, and since this arrow icon is manipulated, the user icon can be immediately moved.

Conversely, in such a case that the shop terminal 3 receives a message from the portable terminal 2, as represented on the screen 2202 of FIG. 22A, since the icon of the user is turned ON in the flicker mode, or the arrow icon is turned ON in the flicker mode, the shop icon is immediately moved to the user icon, and then the shop terminal 3 can immediately resend the message to the user who responds to the shop.

As one mode of the interfaces for communicating the messages between the portable terminal 2 and the shop terminal 3, there is such a method of employing a text based message interface which is interconnected to an icon on a map, which is displayed on a screen 2103 of FIG. 21B and a screen 2203 of FIG. 22B. However, the present invention is not limited only to this message interface. Alternatively, an attribute keyword where the shop is discovered may be displayed in connection with the shop ID near the shop icon. Further, in combination with the above-described method for displaying the position of the user, or instead thereof, while the interactive type interface as shown in the screen 2102 is employed, a total number of shops whose services are being utilized by the user and which are located near the user, and the attribute keywords where the shops are discovered may be displayed in combination with the shop IDs.

When the user performs a process operation for accomplishing this service from the portable terminal 2, the portable terminal 2 transmits such a message of a completion to the control apparatus 1 (step S1714). Then, the control apparatus 1 completes the accessing operation to the DB related to the user and the message waiting process operation, and also, transfers this message to the shop terminal 3 (step S1715). When the shop terminal 3 receives this message (step S1716), the user icon of the user of this portable terminal 2 disappears from the screen of the shop terminal 3.

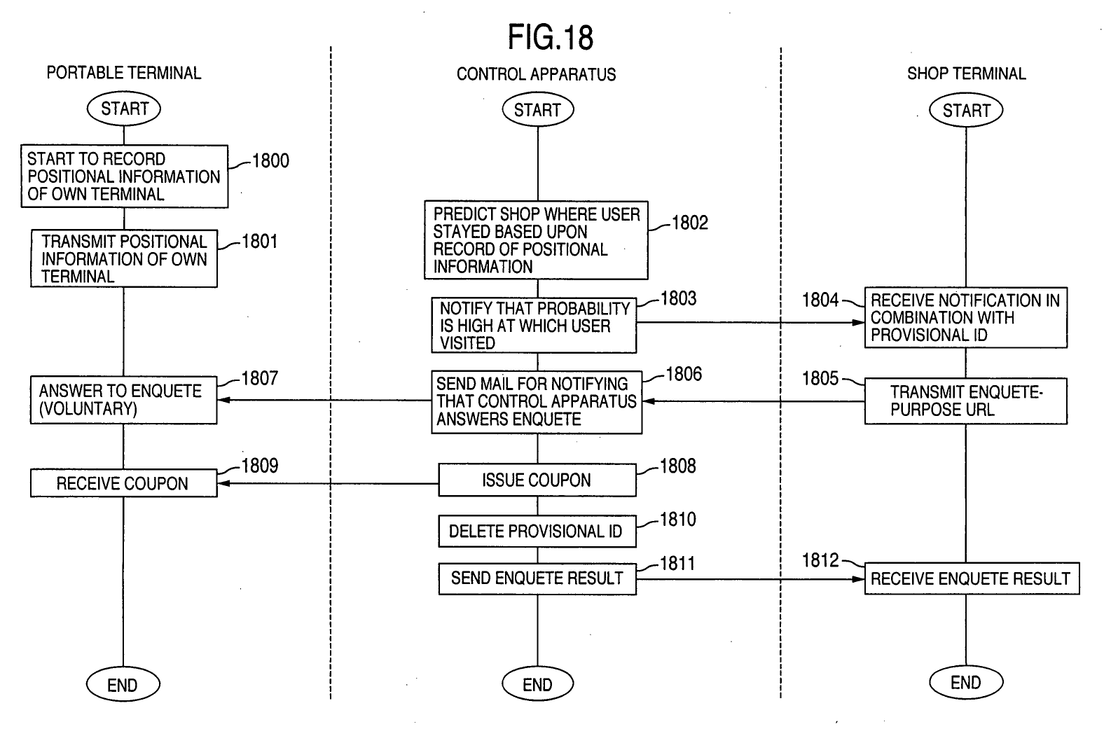

FIG. 18 is a flow chart for explaining a process operation for predicting such a shop which is actually utilized by a user who has received a “calling” action in the control apparatus 1.

The portable terminal 2 commences to record the own position in the memory 22 in a predetermined time interval at the same time when the service of FIG. 17 is commenced (step S1800). For example, the portable terminal 2 may record altitude and latitude information in the unit of 1 minute by using the GPS apparatus 28. After a predetermined time period has elapsed, for example, after 1 hour has passed since the service of FIG. 17 was commenced, the portable terminal 2 transfers the positional information recorded in a time sequential manner to the control apparatus 1 (step S1801). Alternatively, the portable terminal 2 may subsequently transfer the positional information at such a time instant when the service of FIG. 17 is started.

The control apparatus 1 which has received the positional information of the time sequence analyzes the positional information of this time sequential direction so as to predict one, or more shops which may be considered by that the user of the portable terminal 2 utilizes this service and thus stays this shop (step S1802). For instance, in such a case that the user is not moved for a certain constant time period from the same altitude and latitude, and furthermore, a certain shop is located at the place of the same latitude and altitude, the control apparatus 1 may predict that there is high probability that the user utilizes this shop.

Next, the control apparatus 1 notifies that there is the large probability that this user utilize the relevant shop with respect to this shop in combination with the provisional ID (step S1803); the shop terminal 3 receives this notification and ID (step S1804); and the control apparatus 1 transmits a URL of a enquete-purpose Web site of this shop with respect to the user (step S1805). In this case it is so assumed that the shop terminal 3 has previously registered pages of the plural enquete-purpose Web sites in the control apparatus 1, and the pages have been examined by either the control apparatus 1 or the manager thereof. These pages need not be owned by the control apparatus 1, but may be owned by the shop terminal 3.

The control apparatus 1 transfers such a message for requesting the user to answer the enquete while this enquete is brought into viewable status (step S1806), and then, the portable terminal 2 receives this message, and arbitrarily answers this enquete from the Web browser (step S1807). It should be noted that the enquete answer may be made by the intention of the user, and the user can neglect this message.

When the answer of this enquete is sent from the portable terminal 2, the control apparatus 1 transmits a coupon designated by the shop (step S1808), and the portable terminal 2 receives this coupon (step S1809). Furthermore, the control apparatus 1 deletes the provisional ID which has been used by the shop and the user (step S1810).

Thereafter, the control apparatus 1 transfers the enquete result to the shop terminal 3 (step S1811), and then, the shop terminal 3 receives this enquete result (step S1812). It should also be noted that this enquete result may be transferred at the timing when the enquete of the user is acquired, or may be alternatively transferred after a predetermined time has elapsed.

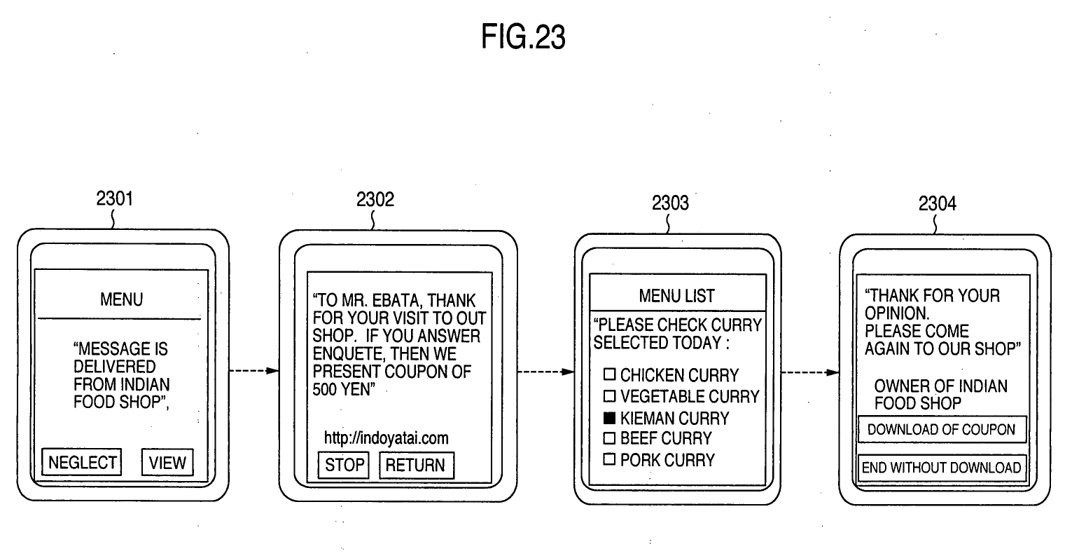

FIG. 23 indicates one mode of the operations performed by the portable terminal 2 from the step S1806 to the step S1809. After the screens (screens 2301 and 2302) have been displayed on which the shop requests the user to answer the enquete, the enquete screen is displayed, and then, the user answers this enquete from the I/F 23 (screen 2303). After the user finishes to make his answer, the user can download the coupon (screen 2304).

The above-described event corresponds to such a method that the positional information is used in order to predict the shop which is actually utilized by the user who has received the “calling” action. In an actual case, such a method is not employed, but another method may be employed. That is, while the IC card 27 equipped on the portable terminal 2 of the user who has visited the shop is employed, the shop visit may be directly notified to the control apparatus 1.

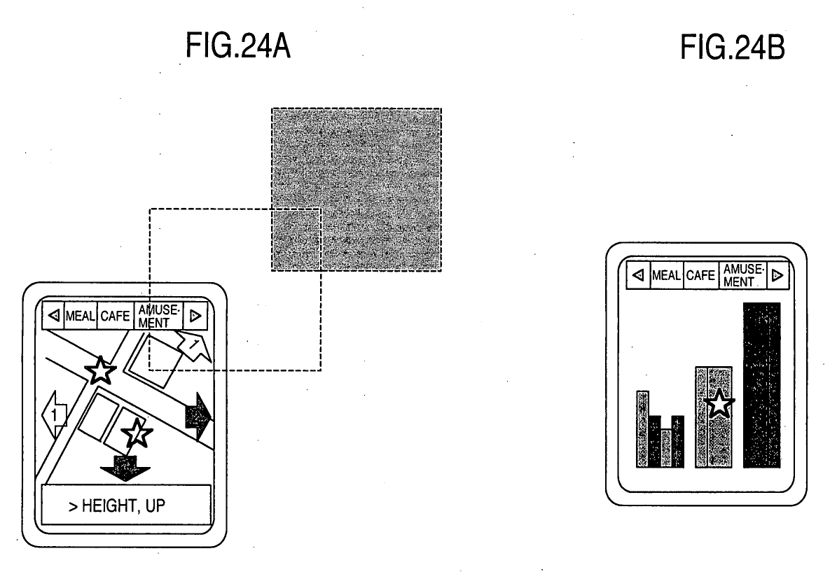

FIG. 24A is a diagram for showing such an image that the user scrolls a map on the portable terminal 2, or a shop manager scrolls the map on the shop terminal 3. In this case, when the user of the portable terminal 2 selects an arrow icon located on an upper right position, the map located along a direction directed to the arrow icon is scrolled in and then is displayed. As images appeared before/after this scroll-in operation, the images are indicated in FIG. 21A and FIG. 23B, or FIG. 22A and FIG. 22B. When the map is moved, in order that the present position of the user (namely, position of ship if shop is located) is not lost, the position of the map data where the own position is indicated is displayed. For example, in FIG. 21B, a contour of an arrow icon at the lower left position is indicated by a wide line, and in FIG. 22B, a contour of an arrow icon along the upper direction is expressed by a wide line, so that the present position of the own user can be immediately confirmed by the user, or the shop manner.

FIG. 24 is a diagram for showing that the user displays the map data from the position of the user along the height direction via the portable terminal 2. The user inputs an instruction of “height and up” from the interface shown in FIG. 24A, so that such a map is displayed which is viewed from the present position of the user on the display in the upper direction. In this drawing, star-signed icons indicate shops which are stored in a building, and these star-signed icons may play the same role as the above-explained icons. It should also be noted that the indication of FIG. 24B may be carried out on the screen of the shop terminal 3.

The data distribution control system according to this embodiment is featured by that the shop side can effectively select the user from the users who have the portable telephones under dynamic -environment; and the temporary and limited communication can be established between the shop and the selected user without disclosing the personal information, which corresponds to the present position of either the shop or the user, so that the highly reliable advertisement distribution can be carried out in the high efficiency, and also, the information related to the tastes of the user can be collected.

While the present invention has been described with reference to the embodiment, the present invention is not limited only to this embodiment, but may be modified without departing from the technical spirit and scope of the invention.

In accordance with this invention, such an advertisement data distributing system can be realized by that the users can be effectively selected from the users under dynamic environment, and the advertisement can be distributed to the selected users.

It should be further understood by those skilled in the art that although the foregoing description has been made on embodiments of the invention, the invention is not limited thereto and various changes and modifications may be made without departing from the spirit of the invention and the scope of the appended claims.

1. A data distribution control system to which a terminal owned by a user, a plurality of computers for transmitting/receiving data, and a control apparatus for controlling data transmitted/received between said computers and said terminal are connected; wherein:
said terminal transmits first data to said control apparatus;
when said control apparatus receives said first data, said control apparatus selects such a computer related to said terminal from said plurality of computers based upon said first data and second data which includes attribute information previously registered in said control apparatus;
said control apparatus transmits third data which contains positional information of said terminal and attribute information of said user with respect to said selected computer; and
when said selected computer receives said third data, said selected computer transmits fourth data in order to call said user with respect to said terminal.

2. A data distribution control system according to claim 1 wherein:
said third data further contains a user ID (identifier) which exclusively indicates said terminal.

3. A data distribution control system according to claim 1 wherein:
said user ID is produced when said control apparatus receives said first data.

4. A data distribution control system according to claim 1 wherein:
said user ID is discarded after said selected computer has transmitted said fourth data.

5. A data distribution control system according to claim 1 wherein:
said control apparatus receives a user ID which exclusively indicates said terminal from said terminal, converts said received user ID into such a data by which said terminal cannot be specified, and thereafter, contains said terminal-not-specified data in said third data.

6. A data distribution control system according to claim 1 wherein:
said terminal receives data from said plurality of computers.

7. A data distribution control system according to claim 1 wherein:
when said terminal receives said fourth data, said terminal displays an icon on a screen of said terminal in an appeal mode.

8. A data distribution control system according to claim 1 wherein:
said control apparatus receives data from a plurality of terminals.

9. A data distribution control system according to claim 1 wherein:
in either said terminal or said computer, when positional information is displayed which does not contain the own position, a recovering means to positional information containing the own position is provided.

10. A data distribution control system according to claim 1 wherein:
in either said terminal or said computer, when a display of a map is changed, map data is moved in a slide mode.

11. A data distribution control system according to claim 1 wherein:
in either said terminal or said computer, when a display of a map is changed, map data is displayed along a height direction.
